(19) United States
(12) Patent Application Publication
(10) Pub. No.: US 2026/0099025 A1
(43) Pub. Date: Apr. 9, 2026

(54) FIBER OPTIC CLOSURE

(71) Applicant: AFL Telecommunications LLC, Duncan, SC (US)

(72) Inventors: Travis Eugene Maddocks, Duncan, SC (US); Johannes Gerhardus Thomas Fritz, Duncan, SC (US); Nathan Thomas Prahl-Andresen, Duncan, SC (US)

(21) Appl. No.: 19/115,616

(22) PCT Filed: Sep. 22, 2023
(86) PCT No.: PCT/US2023/033531

§ 371 Date: Mar. 26, 2025

Related U.S. Application Data
(60) Provisional application No. 63/410,439, filed on Sep. 27, 2022.
(60) Provisional application No. 63/428,851, filed on Nov. 30, 2022.
(60) Provisional application No. 63/442,263, filed on Jan. 31, 2023.

(51) Int. Cl. G02B 6/44

(52) U.S. Cl. CPC G02B 6/4455; G02B 6/44465; G02B 6/4447; G02B 6/44524; G02B 6/44765; G02B 6/44785

(57) ABSTRACT

A fiber optic closure including a base tray including a pair of end walls, a first side wall and a second side wall extending between the pair of end walls, and a base wall extending between the end walls and the side walls. The second side wall forms a first attachment interface configured to receive a connector bank. An interior volume of the closure includes a first side proximate to the first side wall and a second side proximate to the second side wall. The end wall at least partially forms an inlet opening extending from an exterior to the interior volume at the first side. The end wall includes an outlet opening at the second side. The base wall includes a second attachment interface positioned at the first side and configured to receive an organizer tray. At least one second attachment interface is positioned proximate to the end walls.

### PRIORITY STATEMENT

The present application claims the benefit of priority to U.S. patent application No. 63/442,263 titled “FIBER OPTIC CLOSURE”, filed on Jan. 31, 2023, and to U.S. patent application No. 63/428,851 titled “UNIVERSAL FIBER SOLUTION FOR MULTI-DWELLING UNITS”, filed on Nov. 30, 2022, and to U.S. patent application No. 63/410,439 titled “UNIVERSAL FIBER SOLUTION FOR MULTI-DWELLING UNITS”, filed on Sep. 27, 2022, the disclosures of which are incorporated by reference herein in their entirety.

### FIELD

The present disclosure relates generally to telecommunications closures, such as for optical fibers, cables, and transmission elements.

### BACKGROUND

Telecommunications closures, such as optical fiber closures, are used for housing connections between cables, fibers, and other telecommunications equipment. Various types of closures are utilized for various purposes. For instance, closures may be configured as midspan consolidation boxes or as breakout boxes. However, closures configured for one purpose (e.g., consolidation box) may be un-suited for another purpose (e.g., breakout box).

Additionally, closures for residential, commercial, or industrial facilities housing multiple end-users (e.g., multi-dwelling units) may require customized applications across the various users at the facility. Customized application may require unique hardware, attachment points, splices, adaptors, or cable entry locations different from closure to closure.

Accordingly, telecommunications closures addressing one or more of the aforementioned issues would be advantageous. More specifically, an optical fiber closure addressing one or more of the aforementioned issues would be advantageous.

### BRIEF DESCRIPTION

Aspects and advantages of the invention will be set forth in part in the following description, or may be understood from the description, or may be learned through practice of the invention.

An aspect of the present disclosure is directed to a fiber optic closure including a base tray. The base tray includes a first end wall separated along a first axis from a second end wall. The base tray includes a first side wall extending between the pair of end walls and separated along a second axis from a second side wall extending between the pair of end walls. The second side wall forms a first attachment interface configured to receive a connector bank. A base wall extends between the end walls and the side walls. The end walls, the side walls, and the base wall at least partially form an interior volume. The interior volume includes a first side proximate to the first side wall and a second side proximate to the second side wall. Each end wall at least partially forms an inlet opening extending from an exterior of the closure to the interior volume at the first side. Each end wall at least partially form an outlet opening extending from the exterior of the closure to the interior volume at the second side. The base wall includes two or more second attachment interfaces positioned at the first side of the interior volume, the second attachment interfaces configured to receive an organizer tray. At least one second attachment interface is positioned proximate to the first end wall. At least one second attachment interface is positioned proximate to the second end wall.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF FIGURES

A full and enabling disclosure of the present invention, including the best mode thereof, directed to one of ordinary skill in the art, is set forth in the specification, which makes reference to the appended figures, in which:

FIG. 1 provides a perspective view of an embodiment of a telecommunications closure in accordance with aspects of the present disclosure;

FIG. 2A provides another perspective view of the embodiment of the telecommunications closure in accordance with aspects of the present disclosure;

FIG. 2B provides another perspective view of the embodiment of the telecommunications closure in accordance with aspects of the present disclosure;

FIG. 3 provides a perspective view of an embodiment of an interior volume of the telecommunications closure in accordance with aspects of the present disclosure;

FIG. 4 provides a perspective view of an embodiment of the interior volume of the telecommunications closure in accordance with aspects of the present disclosure;

FIG. 5 provides a top-down view of an embodiment of a base tray of the telecommunications closure in accordance with aspects of the present disclosure;

FIG. 6 provides a perspective view of an embodiment of a portion of the interior volume the telecommunications closure in accordance with aspects of the present disclosure;

FIG. 7 provides a perspective view of an embodiment of a portion of the interior volume the telecommunications closure in accordance with aspects of the present disclosure;

FIG. 8 provides a side view of an embodiment of a bracket assembly at the telecommunications closure in accordance with aspects of the present disclosure;

FIG. 9A provides a perspective view of an embodiment of the bracket assembly at the telecommunications closure in accordance with aspects of the present disclosure;

FIG. 9B provides a perspective view of an embodiment of the bracket assembly and tray at the telecommunications closure in accordance with aspects of the present disclosure;

FIG. 10 provides a perspective of an embodiment of a portion of base tray of the telecommunications closure in accordance with aspects of the present disclosure;

FIG. 11 provides a plan view of an embodiment of a telecommunications closure in accordance with aspects of the present disclosure;

FIG. 12 provides a perspective view of a portion of an embodiment of the telecommunications closure in accordance with aspects of the present disclosure;

FIG. 13 provides a perspective view of a portion of an embodiment of the telecommunications closure in accordance with aspects of the present disclosure;

FIG. 14 provides a side view of a portion of an embodiment of the telecommunications closure in accordance with aspects of the present disclosure;

FIG. 15 provides a plan view of an embodiment of the telecommunications closure in accordance with aspects of the present disclosure;

FIG. 16 provides a perspective view of a portion of an embodiment of the telecommunications closure in accordance with aspects of the present disclosure;

FIG. 17 provides a perspective view of a portion of an embodiment of the telecommunications closure in accordance with aspects of the present disclosure;

FIG. 18 provides a perspective view of a portion of an embodiment of the telecommunications closure in accordance with aspects of the present disclosure;

FIG. 19 provides a perspective view of a portion of an embodiment of the telecommunications closure in accordance with aspects of the present disclosure;

FIG. 20 provides a perspective view of an embodiment of the telecommunications closure with trays in an open position in accordance with aspects of the present disclosure;

FIG. 21 provides a perspective view of an embodiment of an interior volume of the telecommunications closure in accordance with aspects of the present disclosure;

FIG. 22 provides a perspective view of an embodiment of a portion of the interior volume of the telecommunications closure of FIG. 21 in accordance with aspects of the present disclosure;

FIG. 23 provides a perspective view of an embodiment of a cable bank, including a detached cable holder portion, for a telecommunications closure in accordance with aspects of the present disclosure;

FIG. 24 provides a perspective view of an embodiment of the cable bank, including a detached cable holder portion, for a telecommunications closure in accordance with aspects of the present disclosure;

FIG. 25 provides a perspective view of an embodiment of the cable bank for a telecommunications closure in accordance with aspects of the present disclosure;

FIG. 26 provides a perspective view of an embodiment of the telecommunications closure in accordance with aspects of the present disclosure; and

FIG. 27 provides a perspective view of a base tray of an embodiment of the telecommunications closure in accordance with aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, “cable routing” or “fiber routing” may refer to one or more transmission lines, such as optical fibers, or furthermore, jackets, sleeves, boots, strength members, ribbons, or pluralities of fibers as may be understood for telecommunications, such as optical fibers, fiber optic cables, etc. into, egressed from, or routed within, telecommunications closures.

Embodiments of a telecommunications closure are depicted and described herein. Embodiments provided herein include a consolidation closure that can be utilized as a multi-dwelling unit (MDU) breakout box, midspan consolidation box, or customizable application box having combinations of connectors, adaptors, cables, fibers, splices, splitters, or other telecommunications devices. The present disclosure generally addresses the above-described issues by providing a consolidation box that can be utilized both as a MDU breakout box (e.g., connection box), or as a midspan consolidation box, or any of a variety of customizable applications as defined by a customer. Additionally, embodiments of the closure provided herein may advantageously allow for an “ambidextrous” installation with a unique internal splice tray attachment structure and adapter field(s) allowing for cable entry to be tailored to the site source cables.

Embodiments provided herein may reduce inventory required or accumulated and associated with different styles of MDU boxes required by the customer. Embodiments provided herein may further reduce costs and technical limitations associated with tooling investment, such as associated with maintaining inventories for different styles of MDU boxes. Still further, or alternatively, embodiments provided herein allow for improved positioning of adapter fields, connectors, cable or fiber routing guides, and other features, such as to provide improved cable management, while further providing an ambidextrous structure.

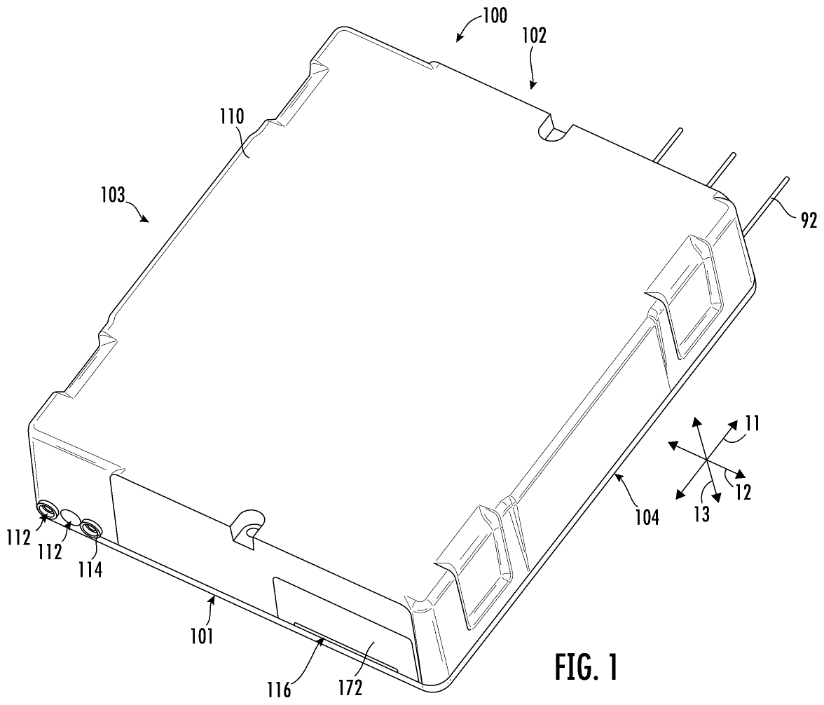

Referring now to the drawings, FIGS. 1-22 depict exemplary embodiments of a telecommunications closure (hereinafter, “closure 100”) are provided herein. The closure 100 includes a base tray 99 including end walls 101, 102, side walls 103, 104, and a base wall 106. For instance, a first end wall 101 is spaced apart from a second end wall 102 along a first axis 11, and a first side wall 103 is spaced apart from a second side wall 104 along a second axis 12 perpendicular to the first axis 11. The end walls 101, 102 extend substantially along the second axis 102 and the side walls 103, 104 extend substantially along the first axis 101. Walls 101, 102, 103, 104 may further extend along a third axis 13 perpendicular to the first axis 11 and the second axis 12. The end walls 101, 102 and side walls 103, 104 are connected together to form a perimeter of the closure 100 (e.g., along the first axis 11 and the second axis 12). An interior volume is formed within the perimeter and along the third axis 13. Cables, trays, modules, and other operational components are contained within the closure 100 at the interior volume, such as further described herein.

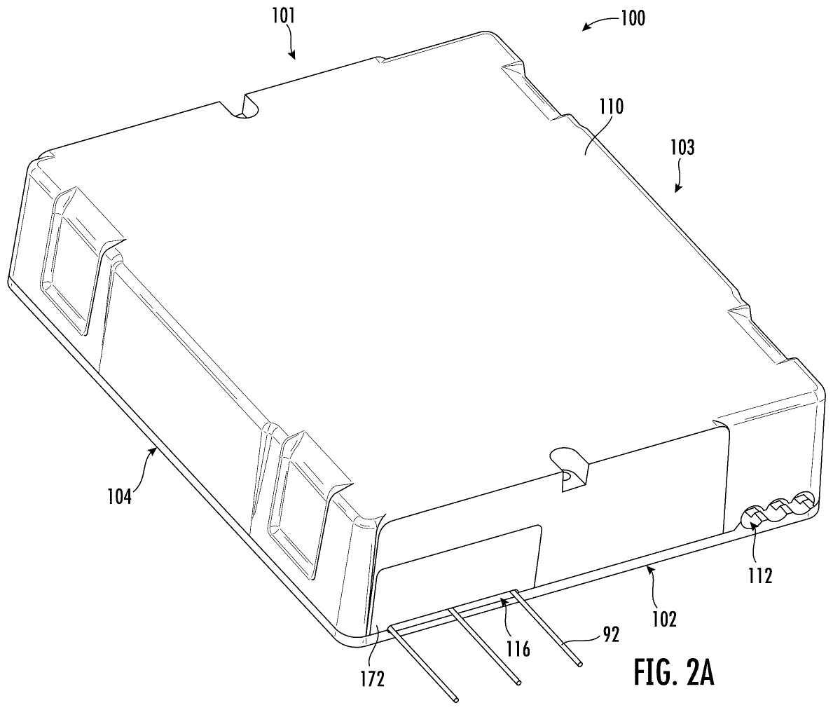

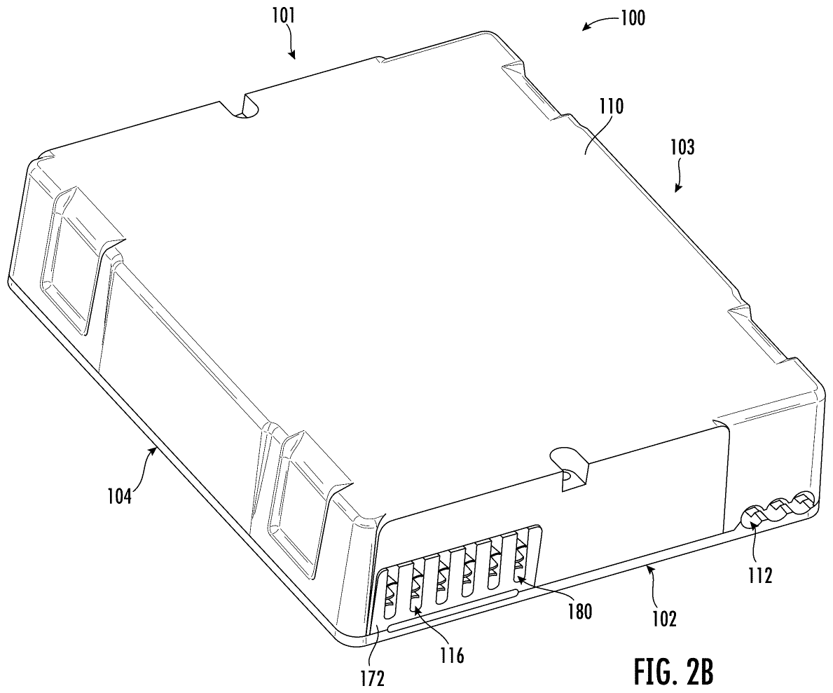

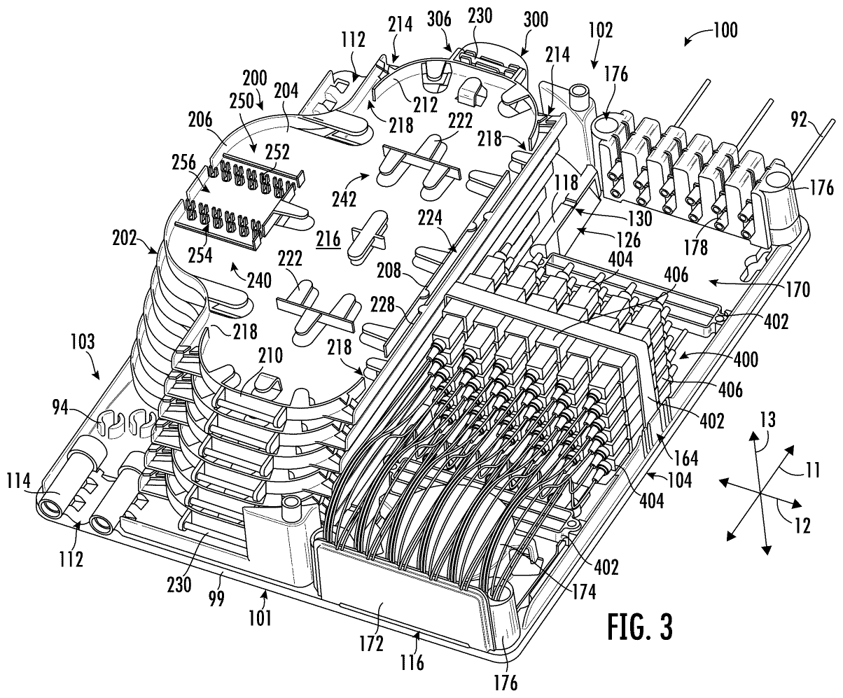

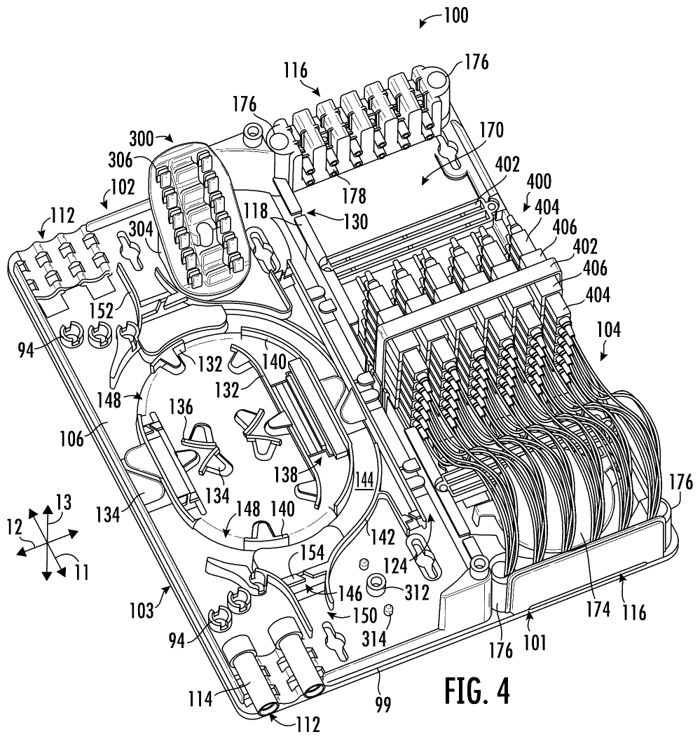

FIG. 1 and FIGS. 2A-2B depict perspective views of the closure 100 including a cover 110 surrounding the interior volume. Cover 110 may include walls extending along the first axis, 11, the second axis 12, and the third axis 13 corresponding substantially to the walls 101, 102, 103, 104, such as to enclose the interior volume. FIGS. 3-4 depict perspective views of the interior volume of the closure 100 (e.g., without cover 110). Referring to FIGS. 1-4, the closure 100 forms a cable inlet opening 112 at the end walls 101, 102. In some embodiments, the cable inlet opening 112 is formed at the cover 110, such as corresponding to positions at the end walls 101, 102. In still some embodiments, a connector 114 may be positioned at the cable inlet opening 112. The connector 114 may include any appropriate type sleeve, gas block, connector, transition component, etc.

It should be appreciated that bare fibers may extend through the cable inlet opening 112. It should be appreciated that gaskets, sealants, seals, etc. may be included such as to mitigate or eliminate fluid communication between an exterior and interior volume of the closure 100 (e.g., inside plant environment rating).

In various embodiments, the closure 100 forms an outlet opening 116 at which a telecommunications wire or cable (e.g., such as depicted at cable 92). The outlet opening 116 may be formed at the end walls 101, 102, the cover at a position corresponding to the end walls 101, 102, or both.

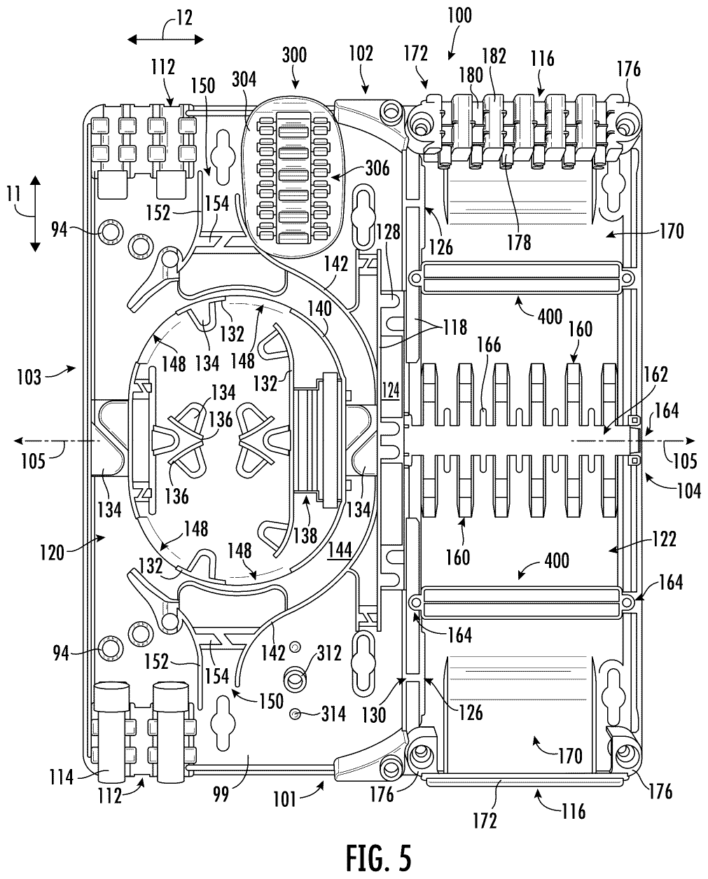

The closure 100 may include the inlet opening 112 at the end walls 101, 102 proximate to the first side wall 103 and the outlet opening 116 at the end walls 101, 102 proximate to the second side wall 104. For instance, referring to the top plan view provided in FIG. 5, a reference centerline axis 105 may extend through the closure 100 substantially co-directional to an extension of the end walls 101, 102. In some embodiments, inlet opening 112 is positioned at the end walls 101, 102 substantially mirror-imaged from one another relative to the reference centerline axis 105. In still some embodiments, outlet opening 116 is positioned at end walls 101, 102 substantially mirror-imaged from one another relative to the reference centerline axis 105. Accordingly, in some embodiments, respective inlet openings 112 at the end walls 101, 102 are positioned opposite one another relative to an extension of the side walls 103, 104. Still further, in some embodiments, respective outlet openings 116 at the end walls 101, 102 are positioned opposite one another relative to an extension of the side walls 103, 104.

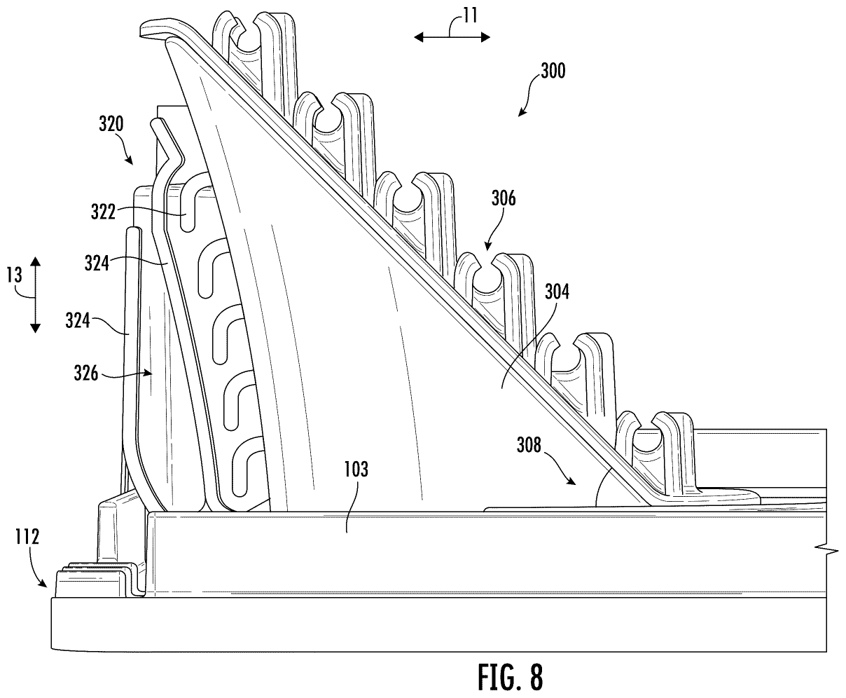

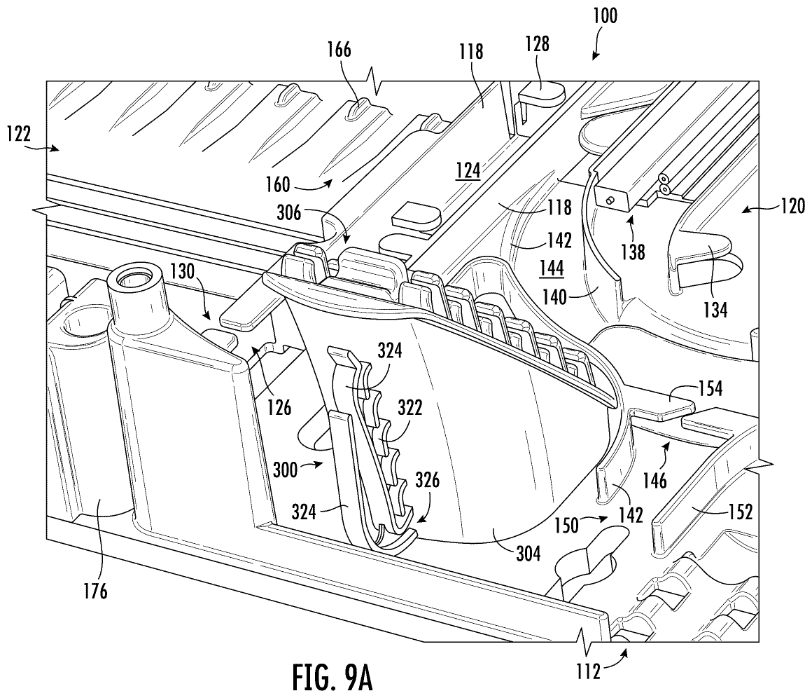

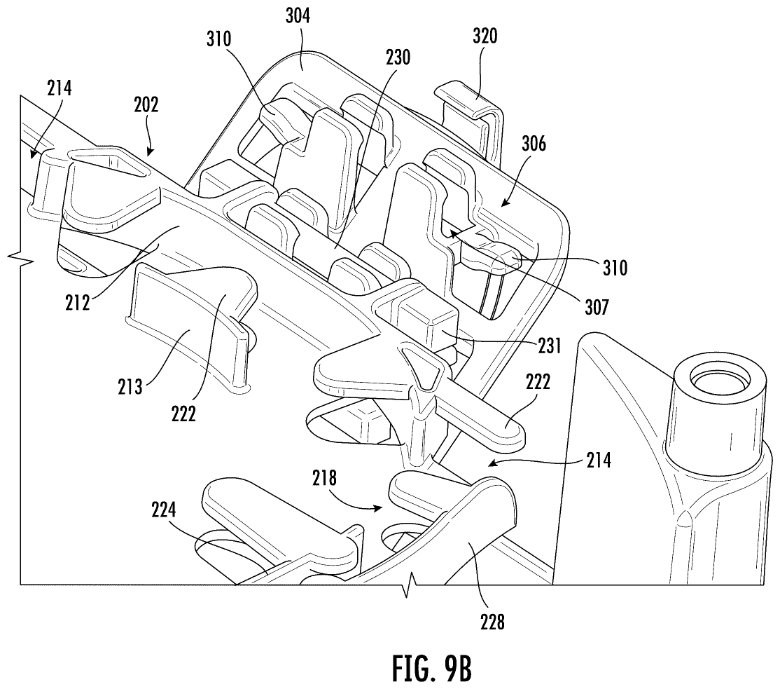

FIG. 3 provides a perspective view depicting an interior volume of an embodiment of the closure 100. The closure 100 includes an embodiment of a tray 200 configured to receive, retain, or organize wires, leads, or cables. FIG. 4 and FIGS. 6-7 provide perspective views depicting an interior volume of an embodiment of the closure 100 without the trays. FIG. 8 and FIGS. 9A-9B further provide views of an embodiment of the closure 100. Referring to FIGS. 3-8, the base wall 106 extends between walls 101, 102, 103, 104, such as to form a base level or platform of the base tray 99. The closure 100 may include a bracket assembly 300 extending along the third axis 13 from the base wall 106. Bracket assembly 300 may include a main body 304 and a plurality of hinge assemblies 306. The hinge assemblies 306 may be spaced apart in a linear array along the third axis 13. In exemplary embodiments, the hinge assemblies 306 are stepped along the third axis 13. In these embodiments, the linear array of the hinge assemblies 306 is angled relative to the third axis 13 (e.g., depicted in FIG. 8 at angle 308), rather than being directed along or parallel to the third axis 13. At least a portion of the main body 304 including the hinge assemblies 306 may also be so angled. Such angle 308 may be between the third axis 13 and the second axis 12, as shown.

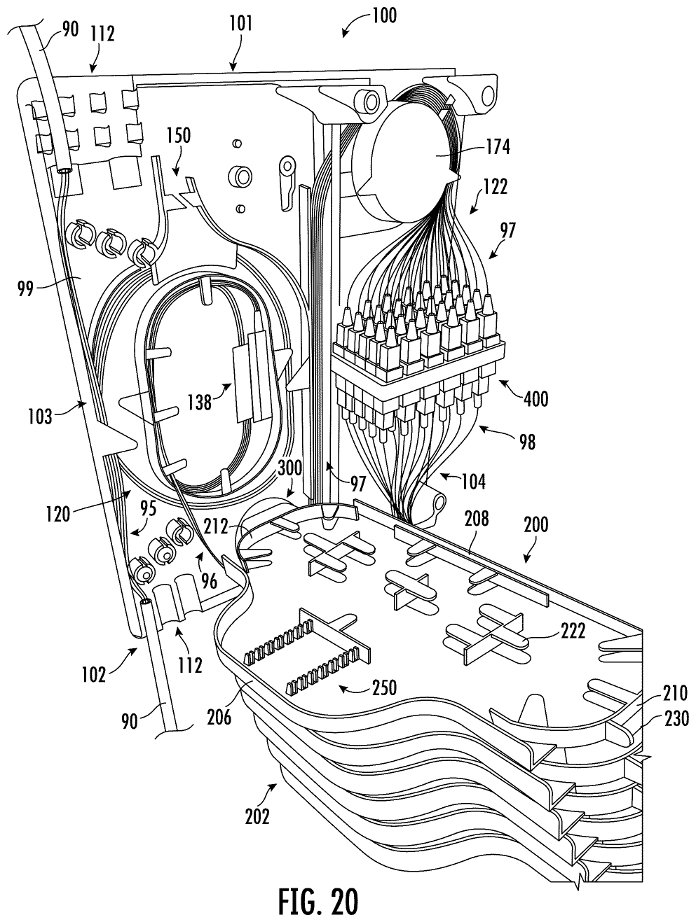

Referring back to FIG. 3, each tray 200 is rotatably connectable, and thus may be rotatably connected, to the bracket assembly 300, such as to one of the plurality of hinge assemblies 306. Each tray 200 may be rotatable, such as between a first position at which the organizer tray 200 is substantially aligned along the second axis 12 (as depicted in FIG. 3) and a second position at which the organizer tray 200 is substantially aligned along the third axis 13 (as depicted in FIG. 20).

For example, each tray 200 may form an organizer tray including a main body 202. Main body 202 may, for example, include a base wall 204, a first sidewall 206, a second sidewall 208, and a first end wall 210, and a second end wall 212. First sidewall 206 and second sidewall 208 may be spaced apart along the second axis 12. End walls 210, 212 may be spaced apart (e.g., along the first axis 11 when in the first position, such as depicted in FIG. 3).

An opening 214 may be formed at the end walls 210, 212 or between the end wall 210, 212 and the adjacent side wall 206, 208. The opening 214 is configured to allow wires, leads, cables, etc. to ingress and egress into and out of an interior volume 216 of the tray 200 formed between the walls 206, 208, 210, 212.

In some embodiments, a channel 218 may be formed between the end wall 210, 212 and an adjacent side wall 206, 208 and extending from the opening 214. A retainer tab 220 may extend from one or both of the end wall 210, 212 or the side wall 206, 208 at the channel 218. The retainer tab 220 may extend at least partially across the channel 218, such as to provide a barrier to bias cables to within the channel 218. The retainer tab 220 may extend partially across the channel 218, such as to form an opening allowing cables to slide upward or downward into or out of the channel 218 (e.g., along the third axis 13 relative to the first position depicted in FIG. 3). In some embodiments, the retainer tab 220 extends from the end wall 210, 212 and the adjacent side walls 206, 208 and a space is formed between the retainer tabs 220, such as to form an opening as described above.

In still some embodiments, tray 200 may further include one or more retainer tabs 222, each of which may extend from a wall, such wall 206, 208, 210, or 212, or an interior wall 213. Such retainer tabs 222 may generally assist in routing and retaining cables and transmission elements in the interior 216 during assembly, splicing, etc., thereof.

In some embodiments, tray 200 includes a splice module 250. The splice module 250 may be removably connected to the tray 200 or formed integrally to the base wall 204. In various embodiments, base wall 204 and first side wall 206 may protrude along the second axis 12, such as to form a protruded portion 240. A module mounting location may be positioned at the protruded portion 240, such as to form a position of the splice module 250 at the base wall 204. The protruded portion 240 may extend toward the first side wall 103 at the closure 100. For example, the protruded portion 240 may position at least a portion of the first side wall 206 substantially co-directional and adjacent to the first side wall 103 at the closure 100. In such embodiments, tray 200 positions the protruded portion 240 adjacent to a routing area 242 at which cables may route or position (e.g., at retainer tabs 222).

The splice module 250 may further include a plurality of partitions 252 extending from a base 256. The plurality of partitions 252 may be generally parallel to each other, and neighboring partitions 252 may define channels 254 therebetween. In some embodiments, partitions 252 extending from the module base wall 256 may extend along a direction between the first axis 11 and the second axis 12 (e.g., relative to the first position), such as an oblique direction. The partition 252 may be deformable to allow a splice sleeve to affix to the splice module 250 between pairs of partitions 252.

In exemplary embodiments, partitions 252 of the splice module 250 may be formed from suitable elastomers, such as vulcanized elastomers. Splice modules 250 may allow versatility and flexibility in accommodating various components, such as, but not limited to, holding triple-stacked single spliced transmission elements, double-stacked ribbon spliced transmission elements, mechanical splices, splitter modules from 1:2 to 1:32, PLCs, etc.

In various embodiments, tray 200 includes a connector arm 230 extending from the main body 202. For example, each connector arm 230 may extend from the base wall 204, such as along the third axis 13 when in the first position (e.g., depicted in FIG. 3). The connector arm 230 may be removably connected to the hinge assembly 306, thus rotatably connecting the tray 200 thereto. For example, connector arm 230 may include a rod, bar, tube, or other member inserted into slots or openings at the hinge assembly 306 to rotatably connect the tray 200 to the hinge assembly 306.

In some embodiments, tray 200 includes the connector arm 230 positioned extending from one or both of end walls 210, 212. For example, the connector arm 230 may extend from the first end wall 210 and the second end wall 212. In some embodiments, the connector arm 230 is positioned adjacent to the routing area 242, such as adjacent along the first axis 11. The connector arm 230 extending from the end walls 210, 212 may allow for rotatable attachment to the bracket assembly 300 at either a first end proximate to the first end wall 101 or a second end proximate to the second end wall 102 along the first axis 11.

Referring particularly to FIGS. 4-5, a hinge assembly attachment interface 302 is formed at the base wall 106. The attachment interface 302 may include a hollow member or tube 312 configured to receive a member or shaft from the bracket assembly 300 (e.g., from an underside of the bracket assembly). The attachment interface 302 may further include one or more positioning members 314 extending from the base wall 106 (e.g., extending along the third axis 13). The positioning members may be configured to extend into an underside of the bracket assembly 300, such as to orient or direct the bracket assembly 300 relative to the base wall 106.

In various embodiments, the attachment interface 302 is positioned proximate to the end walls 101, 102 along the first axis 11. For instance, bracket assembly 300 positioned proximate to the second end wall 102 may be affixed to the base wall 106 at the attachment interface 302 proximate to the second end wall 102. Referring back to FIG. 3, one or more trays 200 may rotatably attach to the bracket assembly 300 at the connector arm 230 extending from the second end wall 212 at the tray 200. In various embodiments and methods for operation, a user may selectively position the bracket assembly 300 at the attachment interface 302 proximate to the first end wall 101. Tray 200 may rotatably attach to the bracket assembly 300 at the connector arm 230 extending from the first end wall 210 at the tray 200. Accordingly, closure 100 may be oriented and re-oriented based on a desired input cable routing, output cable routing, wall attachment, table or other platform attachment, or combinations thereof, while maintaining placement of transmission and operational elements and cable of fiber routing relative to one another within the closure 100.

Referring now to FIGS. 4-7, base tray 99 may include a furcation wall 118 extending from the base wall 106 and extending substantially along the first axis 11. The furcation wall 118 is positioned between the side walls 103, 104 along the second axis 12. The furcation wall 118 separates the interior volume of the closure 100 to a first side 120 and a second side 122. For instance, the first side 120 may substantially form a routing area or cable input side extending between the first side wall 103 and the furcation wall 118. The second side 122 may substantially form a connection area or cable output side extending between the second side wall 104 and the furcation wall 118. Embodiments of the cable inlet opening 112, tray 200, and bracket assembly 300 are positioned at the first side 120. Embodiments of the outlet opening 116 and connector banks 400, such as further described herein, are positioned at the second side 122.

In some embodiments, the furcation wall 118 is a double wall extending substantially co-directional to one another. The furcation wall 118 may form a routing channel 124 extending substantially along the first axis 11. The routing channel 124 may be positioned between the first side 120 and the second side 122, such as to allow for fiber routing along the first axis 11. In some embodiments, the routing channel 124 is positioned substantially along a middle or midway portion of the interior volume. The furcation wall 118 includes an opening 126 through which cables and other routing elements may pass through between the first side 120 and the second side 122. In various embodiments, the opening 126 is positioned proximate to the second end wall 102 (e.g., proximate relative to the reference centerline axis 105). In still various embodiments, the opening 126 is positioned proximate to the first end wall 101 (e.g., proximate relative to the reference centerline axis 105) The furcation wall 118 forming the routing channel 124 may allow for routing of cables to distal ends of the closure 100 along the first axis 11. For instance, the routing channel 124 may allow for fiber routing from proximate to the first end wall 101 to proximate to the second end wall 102, or from proximate the second end wall 102 to proximate to the first end wall 101. The opening 126 may allow for cables to pass from the routing channel 124 to the second side 122.

In some embodiments, a retainer tab 128 extends from the furcation wall 118 into the routing channel 124, such as to facilitate fiber routing, placement, or retention within the routing channel 124. The retainer tab 128 may extend along the second axis 12, or an angle between the first axis 11 and the second axis 12 (e.g., an oblique angle). The retainer tab 128 may be spaced apart from an adjacent furcation wall 118, such as to allow a user to slide a cable or routing element (e.g., along the third axis 13) through a gap between the retainer tab 118 and the adjacent furcation wall 118. In still some embodiments, the furcation wall 118 may be disjointed at the opening 126, such as to form a gap 130 at the opening 126. The gap 130 may allow a user to slide the cable or routing element (e.g., along the third axis 13) through the gap 130 at the furcation wall 118.

Referring still to FIGS. 4-7, the first side 120 of the base tray 99 may form a routing area including a plurality of interior walls 132, 136, 140 from which a plurality of retainer tabs 134 extend. As described herein, the retainer tabs 134 may provide members at which cables and other routing elements may be retained, such as to limit extension along the third axis 13, or to bias the cables toward one or more interior walls 132. In some embodiments, the interior walls 140 may be arranged in an elliptical or parabolic configuration, such as to allow cables to wrap one or more times in a substantially elliptical or parabolic arrangement within the interior walls 140 and retainer members 134. In some embodiments, interior walls 132, 136 are arranged to bias the cables in a substantially circular or ovular configuration. A pair of more of circular or ovular configured interior walls 132, 136 in adjacent arrangement may substantially form a “FIG. 8” arrangement. The “FIG. 8” arrangement may be positioned within the elliptical or parabolic arranged interior wall 132, 136. Embodiments of interior walls 132, 136, 140 or furthermore, retainer tabs 134 extending from the interior walls 132, 136, may advantageously allow a user to wrap and route long lead lines within the closure 100.

Interior walls 132, 136 may be positioned inward of the interior wall 140 forming an inner perimeter interior wall. The first side 120 may further include an outer perimeter interior wall 142 positioned outward of the interior walls 132, 136, 140 (e.g., outward along the first axis 11, the second axis 12, or both). The inner and outer perimeter interior walls 140, 142 may form, at least in part, an outer track 144 therebetween through which cables may route. In some embodiments, interior wall 140 and the first side wall 103 form at least a portion of the outer track 144. The outer track 144 may form a substantially circular, ovular, elliptical, or parabolic configuration. For instance, the outer track 144 may extend radially outward of a routing area formed from interior walls 132, 136, such as described above. In still some embodiments, a splitter or splice module area 138 is formed radially inward of the routing area circumscribed by interior walls 142, or furthermore, between interior walls 142 and first side wall 103. In some embodiments, the splitter or splice module area 138 is formed in a channel or track between interior walls 140, 142. The module area 138 may be configured to facilitate or receive a fiber optic splitter device or fiber optic splice module.

In various embodiments, interior walls 132, 136, 140 may be disjointed from one another, such as to form openings 148 through which the cable may transition between radial tracks. For instance, openings 148 between interior walls 132, 136, 140 may allow cables to route between the “FIG. 8” arrangement and the module area 138 and outer track 144.

The outer perimeter interior walls 142 may form an egress opening 146 configured to allow cables to exit from the routing area between interior walls 132, 136, 140, such as from the outer track 144, the module area 138, or areas at, proximate to, or within interior walls 132, 136, 140, and extend toward the bracket assembly 300.

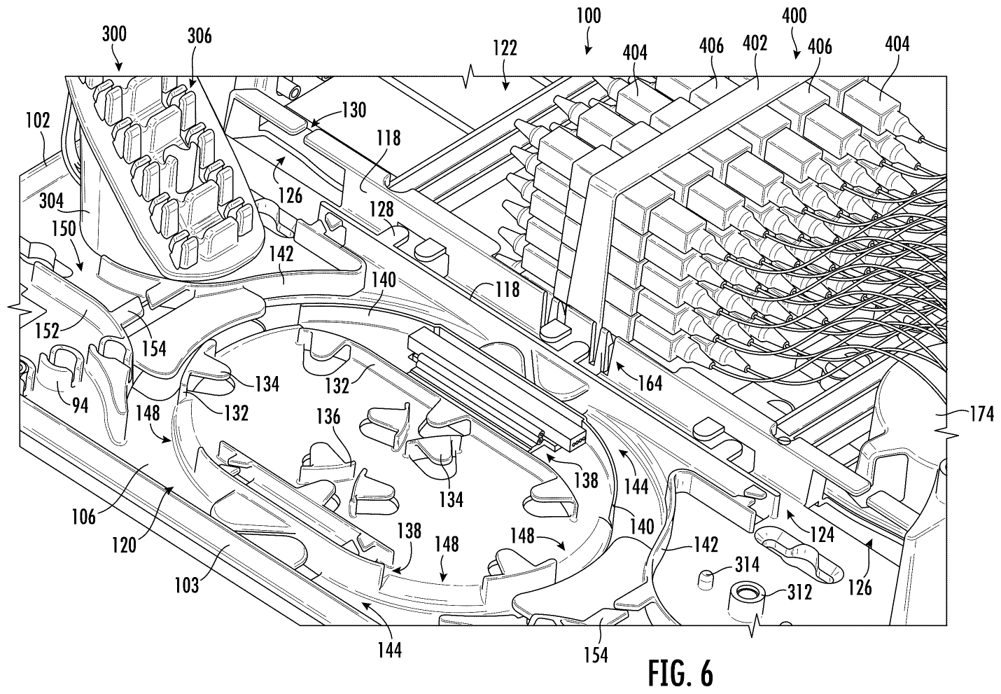

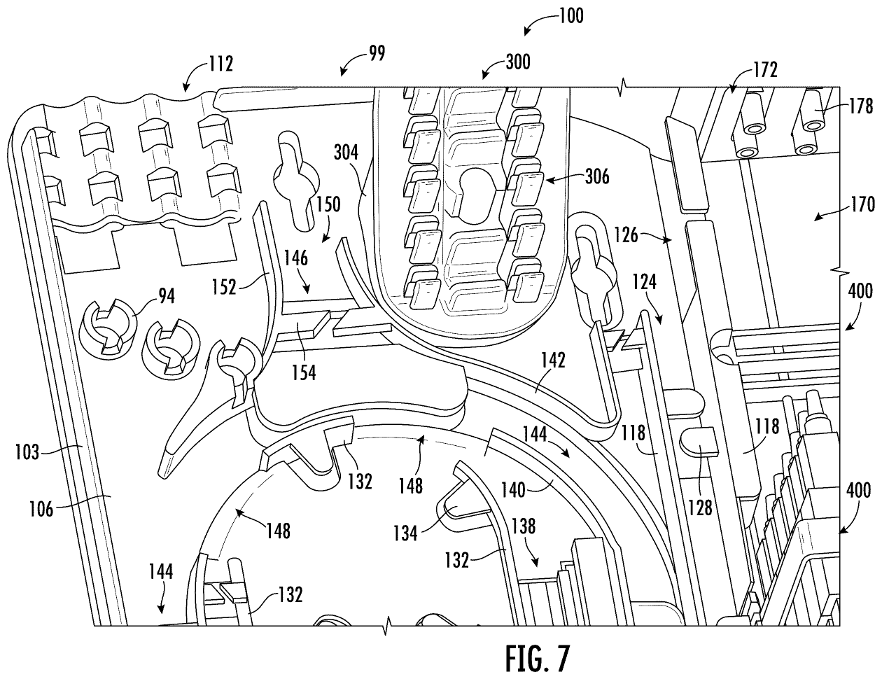

Referring to FIGS. 6-7, in some embodiments, an egress channel 150 is formed extending from the egress opening 146. The channel 150 may be formed from walls 152 extending substantially along the first axis 11. The channel 150 extends toward or alongside the bracket assembly 300 positioned adjacent to at least one of the channel walls 152. For instance, the channel 150 may extend such as to direct cables from the egress opening 146 toward a backside of the bracket assembly 300. The channel 150 or egress opening 146 may include a retainer tab 154 extending from one or both walls 152 into the channel 150. The retainer tab 154 may promote retention of cables within the channel 150. The retainer tabs 154 may form a space or gap between one another, or between the tab 154 and opposing wall 150, such as to allow a user to selectively pass cables into and out of the channel 150 (e.g., along the third axis 13).

Referring now to FIG. 8 and FIGS. 9A-9B, views of the base tray 99 further depicting embodiments of the bracket assembly 300 are provided. FIG. 8 provides a side view of an embodiment of the bracket assembly 300. FIG. 9A provides a view toward the backside of the bracket assembly 300. FIG. 9B provides a perspective view of an embodiment of the tray 200 coupled to the bracket assembly 300 at a hinge assembly 306.

In various embodiments, the bracket assembly 300 may include a cable retainer 320 configured to promote routing of cables along the third axis 13 into and out of the tray(s) 200. The cable retainer 320 may include a hook 322 extending from the main body 304 of the bracket assembly 300. In some embodiments, the hook 322 extends from the backside of the main body 304 (e.g., proximate to the end wall of the closure 100). However, it should be appreciated that the hook 322 may extend from a side portion of the main body 304 (e.g., proximate to the side wall of the closure 100). The bracket assembly 300 may include a plurality of hooks 322. For instance, the hooks 322 may be arranged in adjacent arrangement along the third axis 13. A quantity of hooks 322 may correspond to a quantity of trays 200 at the closure 100. For instance, each hook 322 may correspond in location at the main body 304 to a location along the third axis 13 of the tray 200. The hook 322 may extend downward from the main body 304. The downward extension of the hook 322 may provide a detent along the third axis 13 against cables that may spring, bounce, or push upward along the third axis 13. In some embodiments, the hook 322 may extend upward from the main body 304, such as to provide an area at which cables may rest along the third axis 13.

The bracket assembly 300 may include one or more retention walls 324 extending along the third axis 13. The retention wall 324 may be positioned outward of the hook 322 (e.g., more proximate to the end wall of the closure 100 than the hook 322). One or more retention volumes 326 are formed between the retention wall 324 and the main body 304. For instance, the retention volume 326 may be formed between a pair or more of retention walls 324, or between the retention wall 324 and the hook 322. The retention wall 326 may form a detent configured to limit movement of cables along the first axis 11.

Referring now to FIG. 9B, in some embodiments, the bracket assembly 300 includes a flexible member 310 at the hinge assembly 306. The flexible member 306 extends co-directional to the connector arm 230 when positioned at the hinge assembly 306. The flexible member 306 is configured to receive a portion of the tray 200, such as the connector arm 230 or a contact platform 231, at the hinge assembly 306. The tray 200 may form the contact platform 231 extending alongside the connector arm 230. For instance, the contact platform 231 may form a polygonal blunt body (e.g., square or rectangular body) extending along the second axis 12. The contact platform 231 may be configured to contact or rest upon the flexible member 306. The hinge assembly 306 forms a channel 307 into which the connector arm 230 is received. The flexible member 310 extends from the channel 307, such as along the second axis 12. The connector arm 230 forming a rod or cylindrical structure may allow the tray 200 to rotate between the first position and the second position. The contact platform 231 forming a blunt body (e.g., including a plurality of substantially flat faces) rests upon or contacts the flexible member 310. The faces of the contact platform 231 may facilitate maintaining the tray 200 in the first position or the second position. Accordingly, the contact platform 231 may form a positioning mechanism configured to maintain the tray 200 at a discrete angular position. In various instances, the contact platform 310 may form a spring (e.g., a leaf spring) including a compliant material. The flexible member 310 may be configured to flex (e.g., along the third axis 13) as corners or edges of the contact platform 231 push and displace the flexible member 310 downward along the third axis 13 during rotation of the tray 200 between positions. The flexible member 310 is allowed to re-position (e.g., to a nominal position) when faces at the contact platform 231 are abutting the flexible member 310.

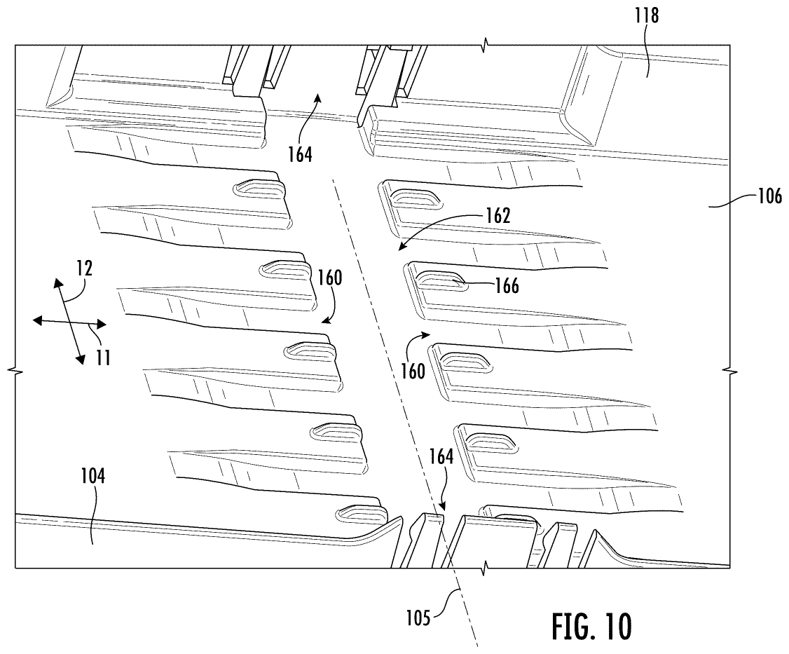

Referring now to FIG. 10, a perspective view of an embodiment of a portion of the second side 122 of the base tray 99 is provided. A channel or groove 160 extends into the base wall 106. The groove 160 may extend substantially along the first axis 11. The groove 160 may further extend along the third axis 13 for a depth into the base wall 106. A channel or trench 162 may extend into the base wall 106 along a direction substantially perpendicular to the groove 160. For instance, the trench 162 may extend substantially along the second axis 12 and along the third axis 13 for a depth into the base wall 106. The trench 162 may extend along a depth substantially similar to the depth of the groove 160 along into the base wall 106. The groove 160 may extend along the first axis 11 from the trench 162. For instance, the groove 160 may extend toward one or both end walls 101, 102 along the first axis 11. In some instances, the groove 160 may extend toward one or both end walls 101, 102 along an oblique angle between the first axis 11 and the second axis 12. The groove 160 and trench 162 may allow cables 92 to extend beneath the connector bank 400 (e.g., FIGS. 3-4, FIG. 6).

Referring to FIGS. 3-4 and FIG. 6, the connector bank 400 may include a frame 402 configured to receive and retain a coupler or adaptor 406. The adaptor 406 may include any device configured to mate or connect ends of a telecommunications cable, such as a fiber optic cable. The adaptor 406 may be configured to simplex, duplex, or other multiple fiber optic cable inputs, or single mode or multi-mode cables, or combinations thereof. The adaptor 406 may be configured to receive a connector 404 at a cable. The connector 404 may include any desired telecommunications connector, such as a fiber optic connector, including, but not limited to, SC, ST, LC, MTP, MPO, etc., or other fiber optic connector, or combinations thereof, including similar connections (e.g., SC to SC, LC to LC, ST to ST, etc.) or dissimilar connections (e.g., SC to ST, LC to SC, etc.), or combinations thereof.

The connector bank 400 may be configured to retain a plurality of adaptors 406 in adjacent arrangement along the second axis 12, along the third axis 13, or both, such as to form a wall of adaptors 406 at which connectors 404 may correspondingly couple. The furcation wall 118, the second side wall 104, or both may form an attachment interface 164 at which the frame 402 is releasably connectable to the base tray 99. The attachment interface 164 may form a clip, recess, tab, tongue and groove, snap, or other desired connection interface at which the frame 402 is selectively and releasably attachable to the furcation wall 118, the second side wall 104, or both.

In some embodiments, the base wall 106 may include tabs 166 extending upward along the third axis 13. The tab 166 may be positioned along the second axis 12 between the furcation wall 118 and the second side wall 104. For instance, the tab 166 may be positioned between the grooves 160 between the furcation wall 118 and the second side wall 104. The tab 166 may form a positioning wall or peg configured to set a position of the frame 402 at the base wall 106. The frame 402 may further include a corresponding opening or slot at which the tab 166 is receivable.

Referring now to FIGS. 3-5, the closure 100 may include an accessory area 170 positioned at the second side 122. The accessory area 170 is positioned proximate to the end wall 101, 102. For instance, the accessory area 170 may be positioned between the furcation wall 118, the second side wall 104, and the first end wall 101 or the second end wall 102. The accessory area 170 may further be positioned adjacent to the connector bank 400. For instance, the second area 122 may be configured in mirror image relative to the centerline axis 105, such as to include the accessory area 170 proximate to the first end wall 101 and the second end wall 102. In various embodiments, such as described herein, the accessory area 170 is configured to receive a spool 174 or other device at which cables may wrap around.

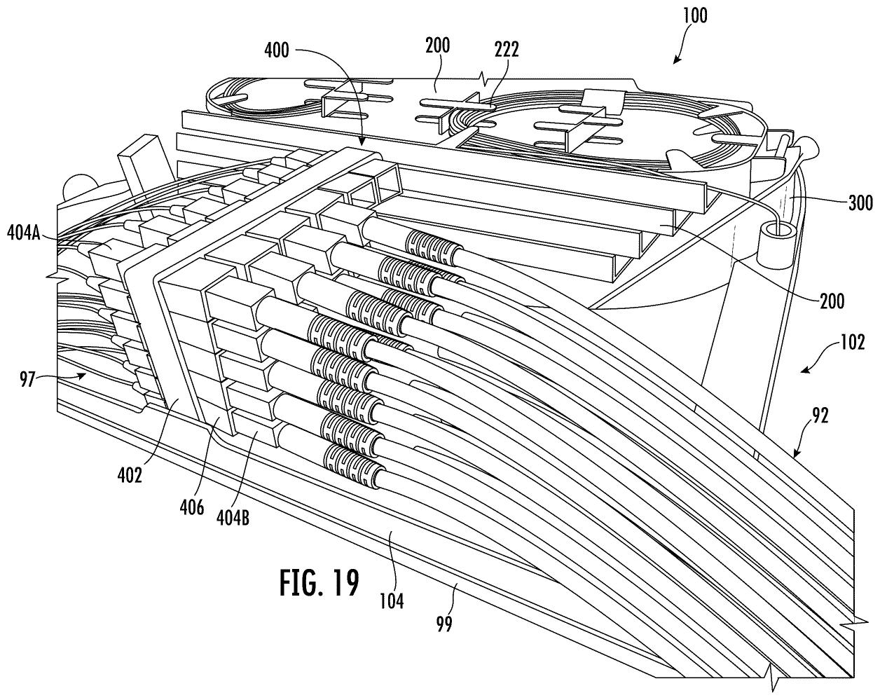

In various embodiments, the closure 100 includes an outlet wall 172. The outlet wall 172 is configured to allow cables 92 to pass through the wall to egress out of the second side 122 (fibers extending from connectors 404 at the connector bank 400 to outlet wall 172 are omitted for clarity in FIGS. 3-4 and FIG. 6). In some embodiments, such as depicted in FIG. 2A, the outlet wall 172 forms the outlet opening 116 as one or more slots extending along the second axis 12. In still some embodiments, such as depicted in FIG. 2B, the outlet wall 172 may include gaskets, tubes, sleeves, or seals 178 through which cables may extend, such as to organize fibers egressing the closure 100 (e.g., such as depicted in FIG. 19) or mitigate fluid communication between the interior volume of the closure 100 and the exterior. The outlet wall 172 may include passages 180 at which the cables 92, or furthermore, seals 178 through which the cables extend, are positioned. For instance, the outlet wall 172 may include a wall 182 extending along the third axis 13 and the first axis 11 to form passages 180. The outlet wall 172 may form a selectively releasably structure configured to be desirably attached and removed at one or both of the end walls 101, 102. The outlet opening 116 may further be formed at corresponding passages 180 at the outlet wall 172.

In some embodiments, outlet wall 172 and base tray 99 include attachment interfaces 176 at which the outlet wall 172 is releasably attachable to the base tray 99. The attachment interface 176 may include a bushing or bore configured to receive a mechanical fastener (e.g., a threaded shank, such as, but not limited to, a screw, bolt, tie rod, etc., a nut, etc.). In some embodiments, the attachment interface 176 may form a clip, recess, tab, tongue and groove, snap, or other desired connection interface.

Embodiments of the closure 100 depicted and described herein may form a consolidation box that can be utilized both as a MDU breakout box (e.g., connection box), or as a midspan consolidation box, or any of a variety of customizable applications as defined by a customer. Embodiments of the closure 100 provided herein may advantageously allow for a reversible or ambidextrous installation or mounting. For instance, cables may route into the interior volume through the inlet opening 112 at either end wall 101, 102 and may egress from the interior volume through outlet opening 116 at either end wall 101, 102 similar or different from the end wall at which the cable entered. The closure 100 may be vertically mounted to a wall or other surface to position the first side 120 at a left-hand side (LHS) and the second side 122 at a right-hand side (RHS), or to position the first side 120 at the RHS and the second side 122 at the LHS. Bracket assembly 300 may be positioned proximate to the first end wall 101 or the second end wall 102 at the bracket attachment interface 302 proximate to the respective end wall 101, 102, such as to allow one or more trays 200 to rotatably attach to the closure 100. For instance, the bracket assembly 300 may be positioned such as to allow the trays 200 to rotate upward or downward regardless of whether the closure 100 is configured in LHS or RHS position. The outlet wall 172 and connector bank 400 may be configured and positioned to output the cables through the outlet opening 116 at the first end wall 101 or the second end wall 102 regardless of whether the closure 100 is configured in LHS or RHS position.

Embodiments of the closure 100 depicted herein include trays 200 having interior volumes 216 facing outward (e.g., toward a user) when positioned parallel to the base wall 106 of the base tray 99, such as may allow a user to work at leads, components, and perform tasks at the tray 200 when the base wall 204 of the tray 200 is positioned parallel to the base wall 106 of the base tray 99 (e.g., a first position). However, it should be appreciated that embodiments of the closure 100 may include the tray 200 having the interior volume 216 facing inward (e.g., away from the user) when positioned parallel to the base wall 106 of the base tray 99 (e.g., the base wall 206 of the tray 200 may face toward the user when in the first position). In some embodiments, the bracket assembly 300 can be positioned to rotate the tray 200 downward, such as to position the base wall 206 substantially perpendicular to the base wall 106 (e.g., a second position). The tray 200 may allow the interior volume 216 to be facing outward when the tray 200 is in the second position.

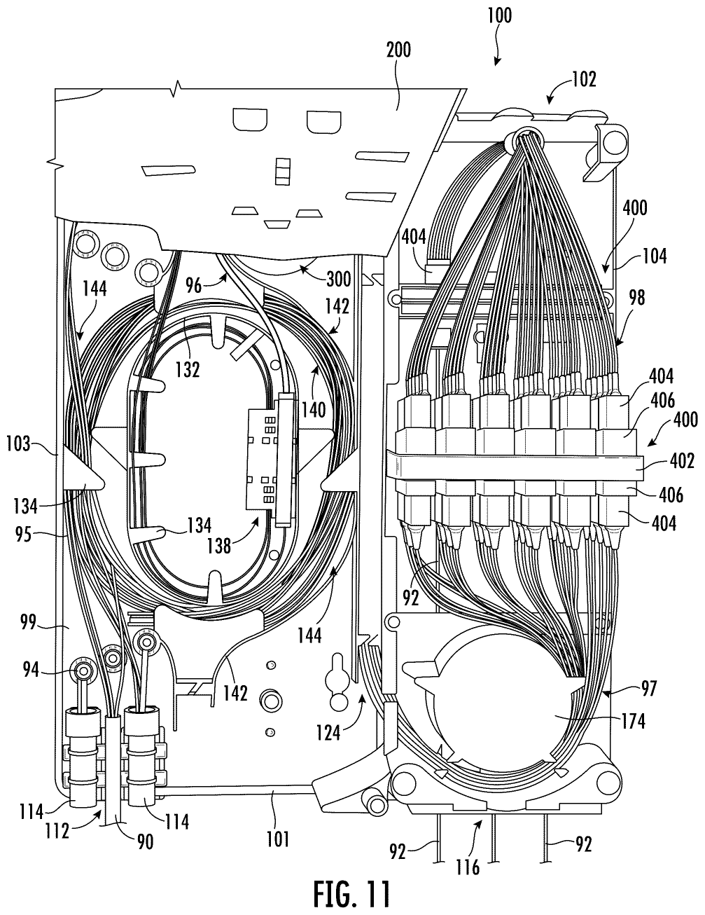

Referring to FIGS. 11-18, an exemplary embodiment of the closure 100 is provided. FIGS. 11-18 depict and exemplary configuration of the bracket assembly 300, trays 200, connector bank 400 and fiber routing at the closure 100. It should be appreciated that FIGS. 11-18 depict one of many configurations allowed by embodiments of the closure 100 depicted and described herein in regard to FIGS. 1-10.

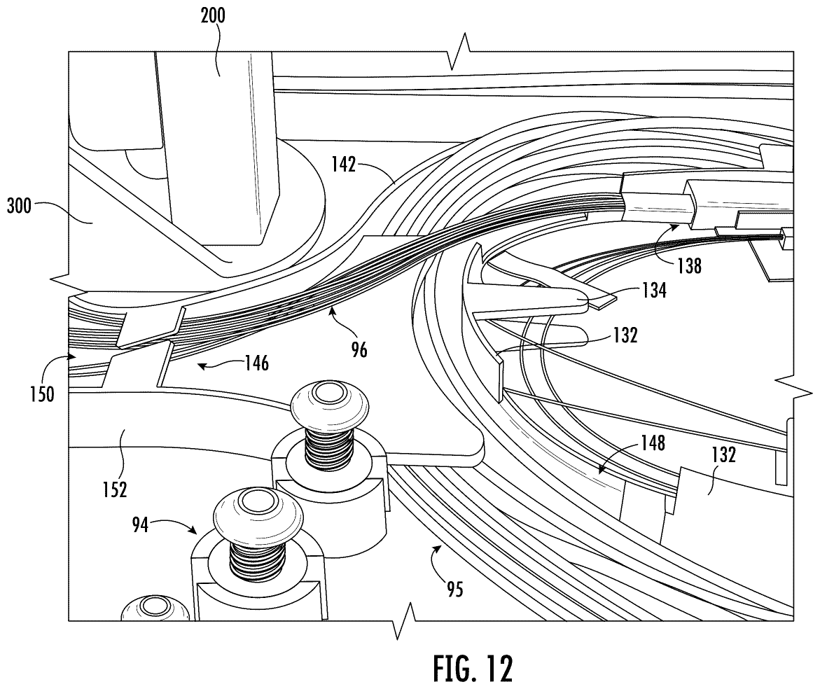

In FIGS. 11-18, a plurality of input cables 90 is configured to enter the closure 100 through the inlet opening 112 at the first end wall 101 and the second end wall 102. Mount interface 94 may allow the cable 90, or portions thereof (e.g., fibers, sleeves, jackets, boots, etc.) to be attached and affixed to the base tray 99. The first side 120 includes interior walls 132, 136, 140, 142 and retainer tabs 134 configured in substantially a racetrack, elliptical, or ovular arrangement, such as to allow cables or fibers, such as depicted at fibers 95, to route in one or more rotations around the interior walls 132, 136, 140, 142 in corresponding racetrack, elliptical, or ovular arrangement. The fibers 95 route to the splitter or splice module area 138. For instance, fibers 95 or other leads may split or splice at the module area 138 and one or more output fibers (e.g., a ribbon fiber), such as depicted at fibers 96, extend toward the egress opening 146. FIG. 12 depicts in further detail an exemplary routing of the cables in around the first side 120, such as described above, and fibers 96 extending from the module area 138 through the egress opening 146 and egress channel 150.

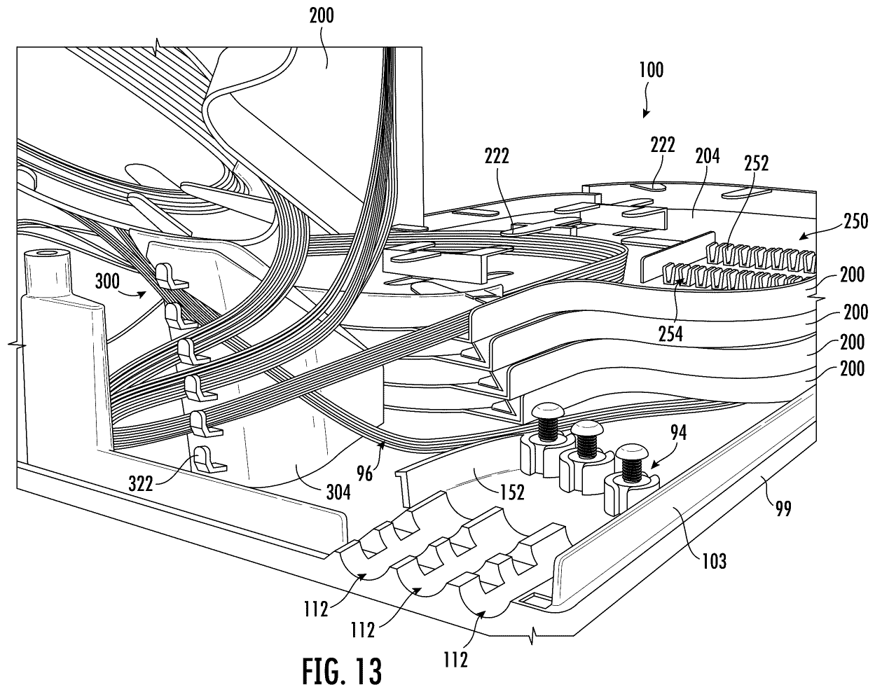

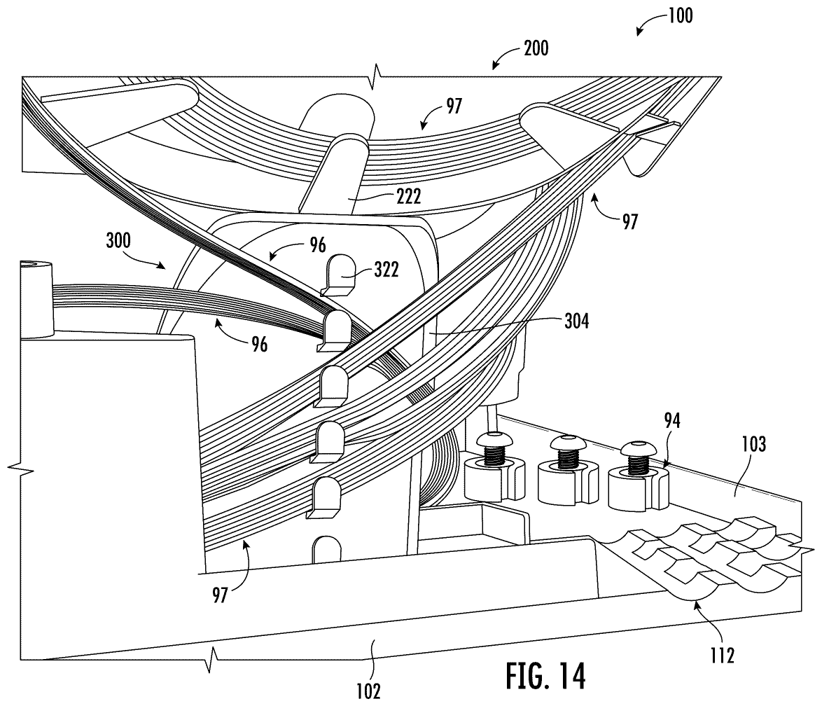

FIGS. 13-14 depict a backside of the bracket assembly 300 positioned proximate to the second end wall 102. For instance, FIGS. 13-14 depict fibers 96 extending from the egress channel 150 (such as depicted in FIGS. 11-12) around the bracket assembly 300 to the cable retainer 320.

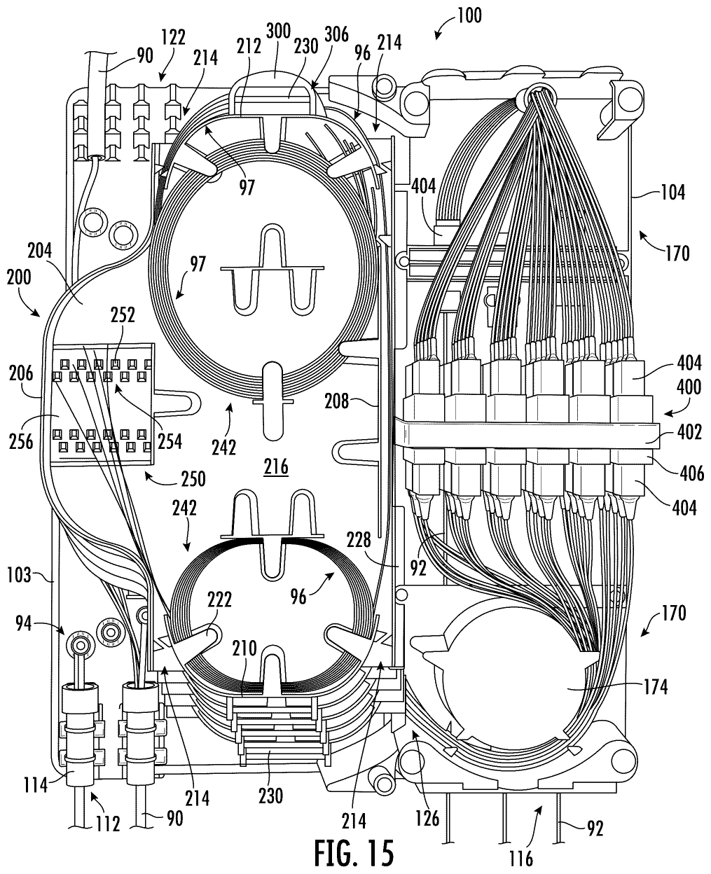

FIG. 15 depicts a plan view at which the plurality of trays 200 is positioned in the first position. In the exemplary embodiment provided, fibers 96 are received into an interior volume of the tray 200 through opening 214, or furthermore, through channel 218, proximate to the second end wall 102 and bracket assembly 300. Fibers 96 are routed from the opening 214 proximate to the second end wall 102 toward the first end wall 101. Retainer tabs 222 such as described herein are positioned to allow the fibers 96 to route in a substantially circular, ovular, racetrack, or elliptical arrangement proximate to the first end wall 101. The fibers 96 are routed to the splice module 250 at the tray 200 at which splices may be performed. Spliced fibers, such as depicted at fibers 97, may be routed from the splice module 250 in circular, ovular, racetrack, or elliptical arrangement proximate to the second end wall 102. Fibers 97 egress through channel 218 proximate to the second end wall 102 (e.g., opposite along the second axis 12 from the channel 218 through which the ribbon cable entered the tray 200). Fibers 97 may generally enter and egress the tray 200 through openings 214 or channels 218 proximate to the bracket assembly 300 (e.g., openings 214 and channels 218 proximate to the second end wall 102 in the embodiment depicted and distal to openings 214 and channels 218 proximate to the first end wall 101). Fibers 97 entering and egressing the tray 200 such as described herein may allow the tray 200 to rotate between first and second positions such as described herein.

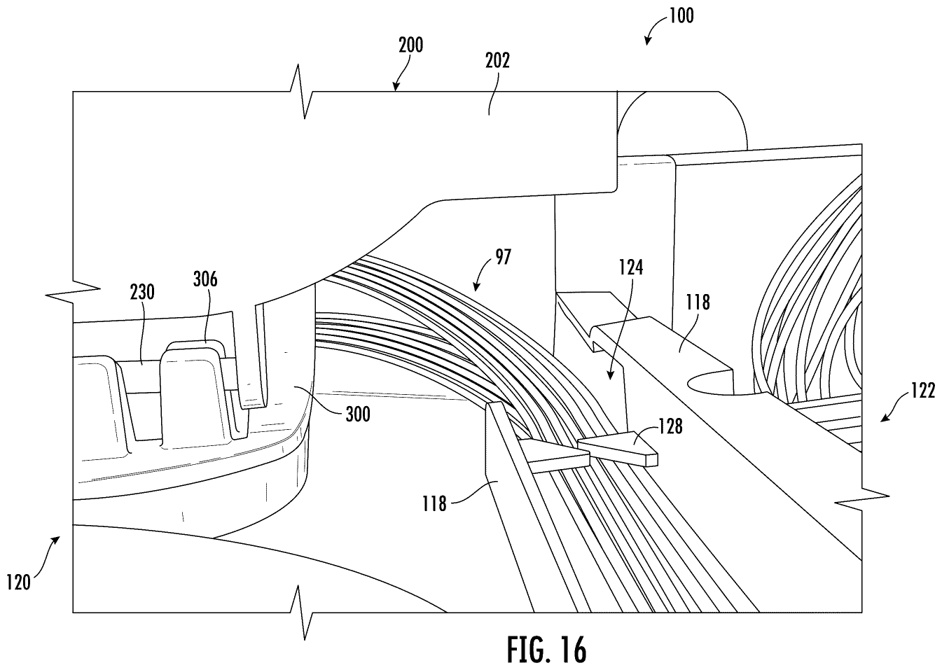

Referring back to FIGS. 13-14, fibers 97 are depicted egressing trays 200 and routing along the backside of the bracket assembly 300 and retained at the cable retainer 320. FIG. 16 depicts fibers 97 routing from the backside of the bracket assembly 300 (such as depicted in FIGS. 13-14) and through the routing channel 124 positioned between the first side 120 and the second side 122. In the embodiment depicted in FIG. 16, fibers 97 are routed from proximate to the second end wall 102 along the first axis 11 toward the first end wall 101. Retainer tabs 128 extending into the routing channel 124 may promote retention of the cables within the routing channel 124.

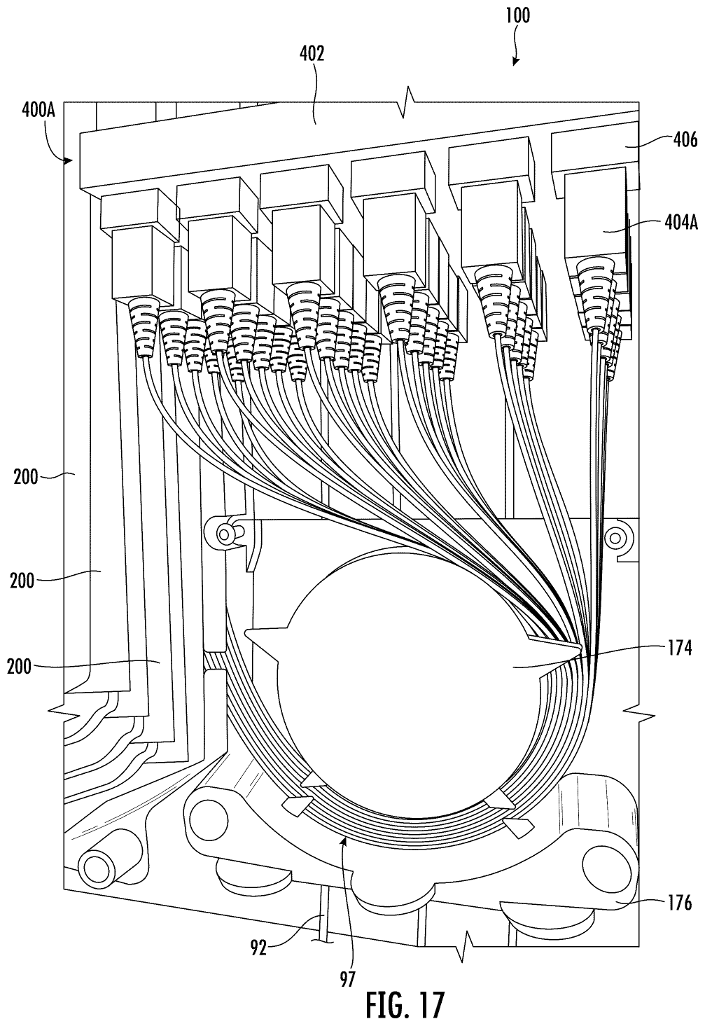

Referring back to FIG. 15, and further depicted in FIG. 17, fibers 97 egress from the routing channel 124 into the second side 122 through the opening 126 proximate to the first end wall 101. Fibers 97 may route at least partially circumferentially around the spool 174 positioned at the accessory area 170 proximate to the first end wall 101. Fibers 97 may be connectorized to include any desired connector 404A, such as described above, and selectively coupled to adaptors 406 at the connector bank 400. The connector bank 400 may form a first connector bank 400A positioned substantially along the centerline reference axis 105.

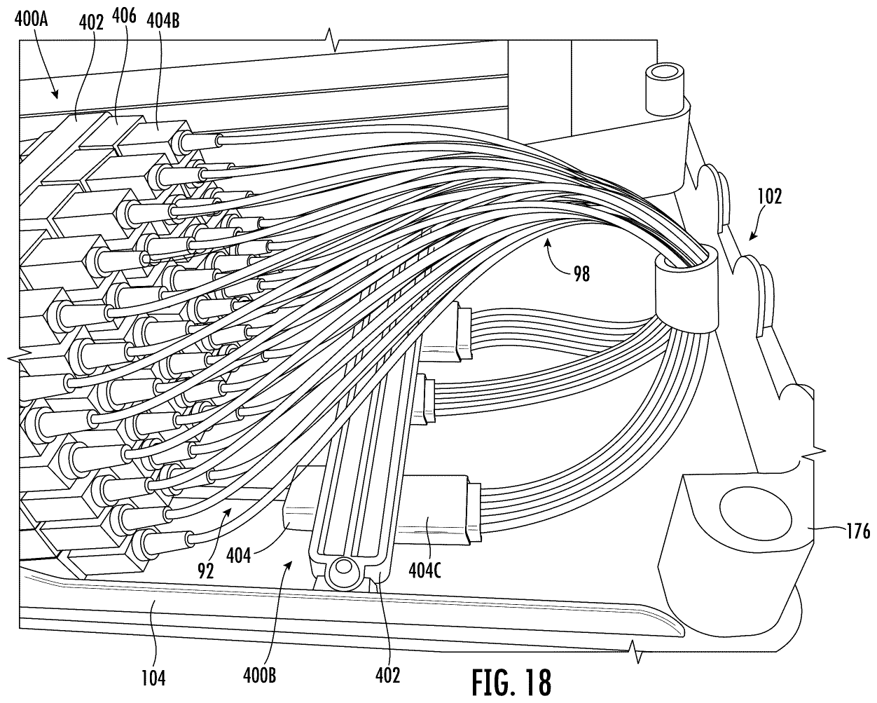

Referring still to FIG. 15, and further depicted in FIG. 18, output fibers 98 from the first connector bank 400A may include connectors 404B operably coupled to adaptors 406 and connectors 404A from fibers 97. Fibers 98 may be routed to a second connector bank 400B positioned at the accessory area 170 proximate to the second end wall 102. The second connector bank 400B may include connectors 404C and adaptors configured to provide output fibers or cables 92. The output cables 92 may extend along the second axis 12 beneath the first connector bank 400A (e.g., via groove 160, trench 162) and spool 174 from proximate the second end wall 102 to the output opening 116 at the first end wall 101.

Embodiments depicted in FIGS. 11-18 depict an exemplary method for routing cables or fibers at a closure. For instance, embodiments depicted in FIGS. 11-18 depict cable or fiber routing from the first side 120 through the first end wall 101 and along one or more loops within the first side 120 before routing toward the second end wall 102, and further routing along the third axis 13 to one or more trays 200 positioned in adjacent arrangement along the third axis 13. Fiber routing may continue from proximate to the second end wall 102 toward the first end wall 101 and back toward the second end wall 102. Fibers may route in one or more loops between the first and second end walls 101, 102 before egressing from the tray 200 proximate to the second end wall 102. Fibers may further route from proximate to the second end wall 102 through the routing channel 124 toward the first end wall 101. Fibers may route from proximate to the first end wall 101 to the second end wall 102 and back toward the first end wall 101, and may further include one or more loops between the first and second end walls 101, 102.

Referring to FIG. 19, an embodiment of the closure 100 is provided. The embodiment depicted in FIG. 19 may be configured substantially as described in regard to FIGS. 3-5 or FIGS. 11-18. FIG. 19 may depict an embodiment of the closure 100 in which outlet wall 172 is omitted for clarity. In FIG. 19, output connectors at the connector bank 400 may be configured to egress the through the second end wall 102 at the closure 100. Accordingly, FIG. 19 depicts an exemplary embodiment of the closure 100 allowing for connector types at the connector bank 400 to be selected or changed based on an end user or other user requirement. For instance, fibers egressing the closure 100 may be positioned through seals 178 or passages 180, such as depicted in FIGS. 3-5.

Embodiments of the closure 100 depicted and described herein allow for three dimensional fiber routing, such as along the first axis 11 between end walls 101, 102, along the third axis 13 to and from trays 200, along the second axis 12 from the first side 120 to the second side 122, or, furthermore, along the third axis 13 beneath the connector bank 400. Embodiments of the closure 100 allow for iterations of fiber routing along the first axis 11, such as along the first side 120 at the base tray 99, along the tray 200, along the routing channel 124, and along the second side 122 at the base tray 99. Embodiments of the closure 100 allow for iterations of fiber routing along the second axis 12, such as in loops at the first side 120 of the base tray 99 or at the tray 200, or through channels 218 at the tray 200 separated along the second axis 12, or through openings 126 extending through the furcation wall 118 allowing routing from the first side 120 to the second side 122, or in loops at the second side 122 at the spool 174. Embodiments of the closure 100 allow for iterations of fiber routing along the third axis 13, such as along trays 200 stacked in adjacent arrangement at the bracket assembly 300, or connections in adjacent arrangement along the third axis 13 at the connector bank 400, or cables extending beneath the connector bank 400, such as through grooves 160 or trench 162.

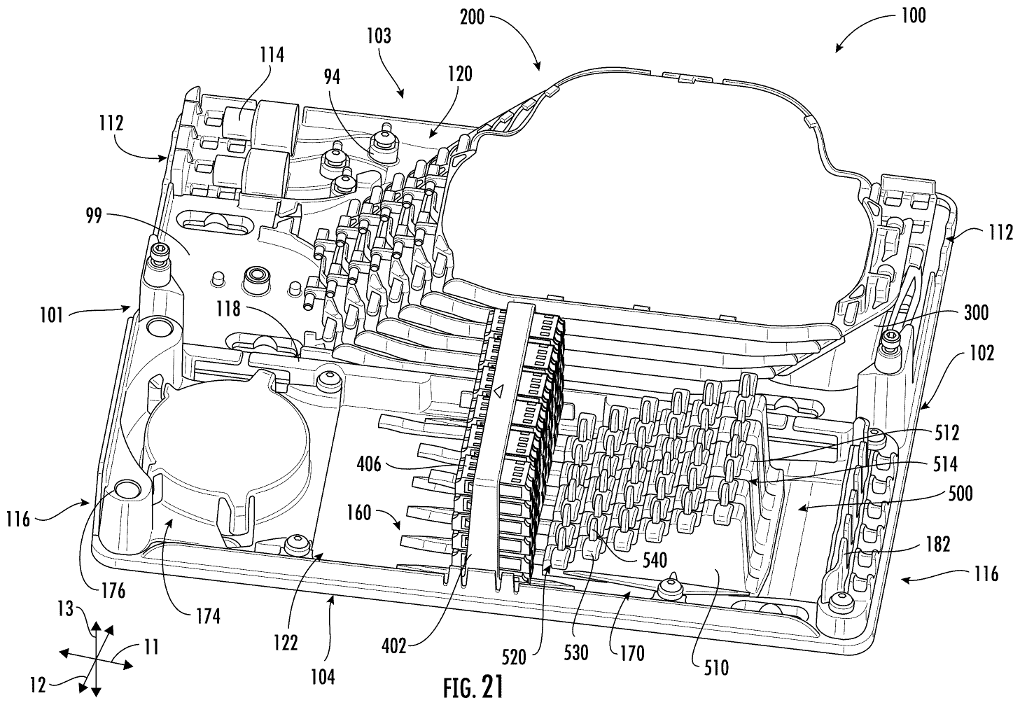

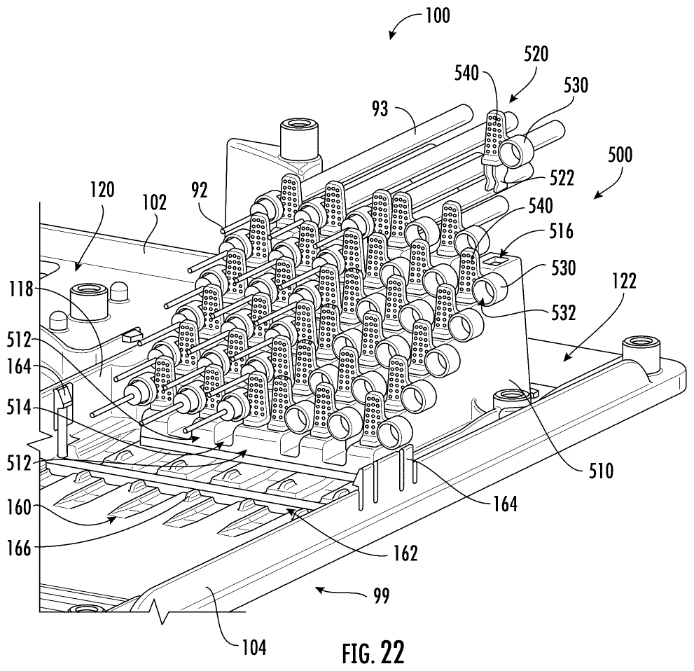

Referring now to FIG. 21-22, perspective views of an embodiment of the closure 100 are provided. The closure 100 depicted in FIGS. 21-22 is configured substantially in accordance with one or more embodiments such as described in regard to FIGS. 1-20. It should be appreciated that portions of the closure 100 may be omitted for clarity, such as to depict other portions or components of the closure 100. FIGS. 21-22 depict embodiments of a cable bank 500 coupled to the base tray 99. Embodiments of the cable bank 500 may be positioned at the second side 122, such as at the accessory area 170. Embodiments of the cable bank 500 are configured to hold and organize a plurality of cables, such as cables 92 egressing from the connector bank 400.

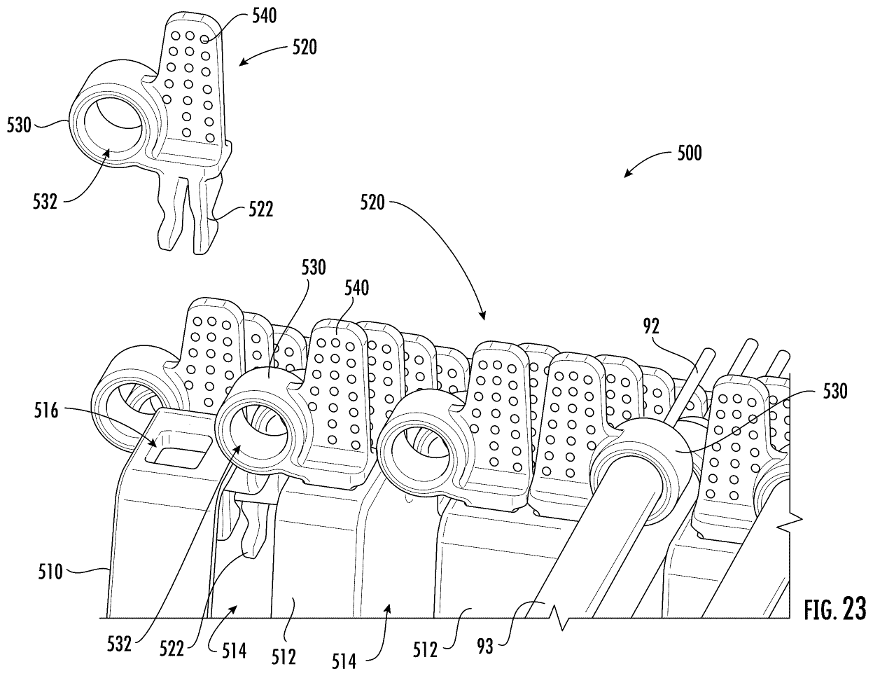

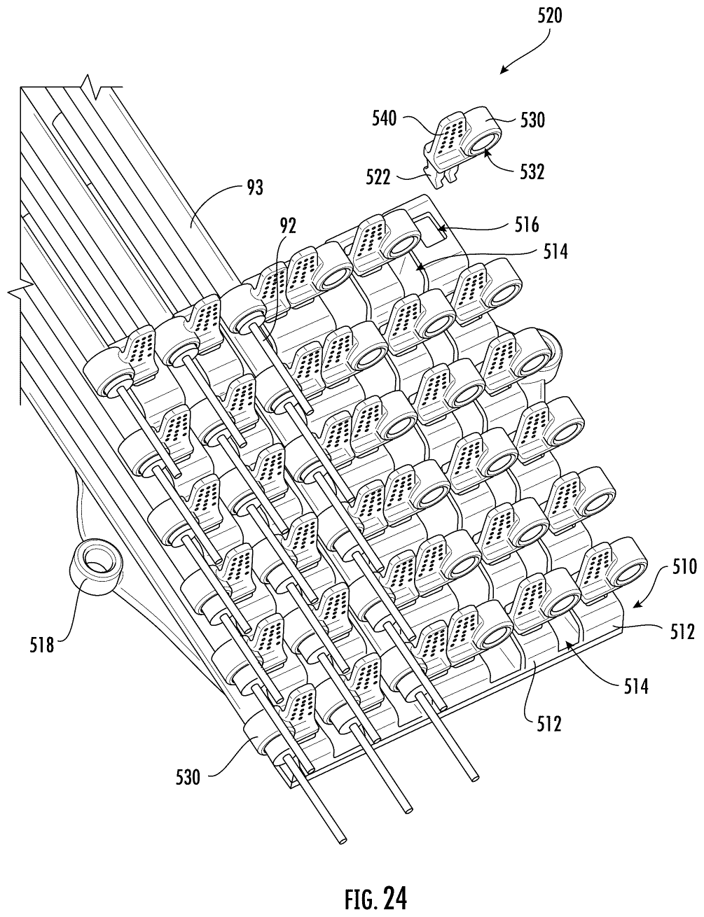

FIGS. 22-24 provide perspective views of an embodiment of the cable bank 500 including an embodiment of a cable holder 520 detached from a cable bank body 510. The body 510 includes a plurality of holder openings 516 at which a respective cable holder 520 is insertable. The cable holder 520 includes a grip portion 540 and a pin or leg 522. The grip portion 540 may include a protrusion, groove, raised material, or other textured surface at a wall or member at which a user may hold the cable holder 520. The leg 522 is configured to insert into the opening 516. In some embodiments, the leg 522 is a pair of members configured to extend divergently from a base portion (e.g., at the grip portion 540). The leg 522 is configured to elastically deform or spring, such as to promote retention of the cable holder 520 within the opening 516 and allow for selective removal and re-entry to the opening 516 by a user.

The cable holder 520 includes a holder channel 530 forming a cable opening 532 at which the cable is received. For instance, the cable 92 may include an outer jacket 93 at which the holder channel 530 is configured to retain the cable 92. The holder channel 530 may form a wall at least partially surrounding the cable 92. For instance, the holder channel 530 may include a wall at least partially surrounding and contacting the outer jacket 93, such as to retain the cable 92 at the cable holder 520. A user may insert the cable 92 to the holder channel 530 individually or separately from the body 510 and insert the cable holder 520 into the opening 516 at the body 510. Selective placement and removal of the cable holder 520 allows the plurality of cables 92 (e.g., cables 92 egressing from the connector bank 400) to be individually serviced, removed, placed, or retained without requiring handling of one or more other cables.

In various embodiments, cable bank body 510 forms a step structure at which openings 516 are arranged along a lateral axis, a transverse axis, and a vertical axis, such as along the first axis 11, the second axis 12, and the third axis 13. The body 510 may form a channel 514 allowing each cable 92 to extend through the body 510. For instance, channel 514 extends along the first axis 11 relative to the closure 100, such as to allow the cables 92 to extend from the connector bank 400 toward the second end wall 102. In some embodiments, the body 510 forms a plurality of channels 514 separated along the second axis 12 (relative to the body 510 installed to the closure 100) by a wall 512. The wall 512 may include a row of openings 516, such as extending in step arrangement along the third axis 13 and separated from one another along the first axis 11.

The body 510 may receive cable holder 520 at the opening 516 such as to position the holder channel 530 at or above the channel 514. The cable holder 520 may be positioned at the opening 516 to place the holder channel 530 to an outside face of the body 510 (e.g., a side along the second axis 12 relative to the body 510 positioned to the closure 100).

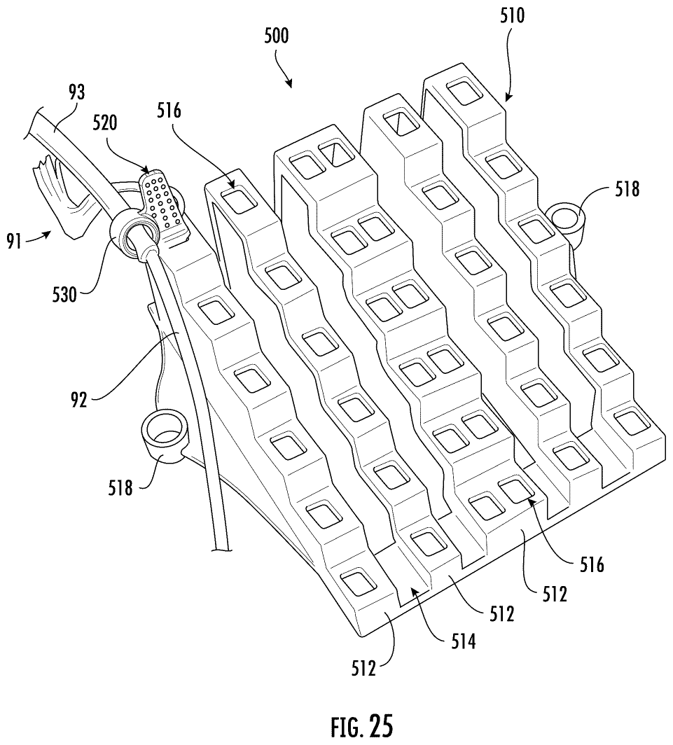

Referring briefly to FIG. 25, a perspective view of an embodiment of the cable bank 500 is provided. The body 510 may include an attachment interface 518, such as forming an opening or surface configured to receive a fastener (e.g., a threaded member, clip, clamp, tie-wrap, etc.).

In various embodiment, the cable 92 may include a strength member 91, such as an aramid fiber, positioned between the optical fiber and the outer jacket 93. A user may extend a portion of the strength member 91 from the outer jacket 93 and wrap the strength member 91 around the leg 522. The user may push the leg 522 including the strength member 91 into the opening 516, such as to secure or affix the cable 92 to the cable holder 520 and body 510.

In still some embodiments, the holder channel 530 may form a converging and/or diverging structure at the cable opening 532, such as to retain the cable 92, or the outer jacket 93 of the cable 92, within the opening 532. In still some embodiments, protrusions, members, or teeth may be formed within the holder channel 530 to retain the cable 92 within the opening 532.

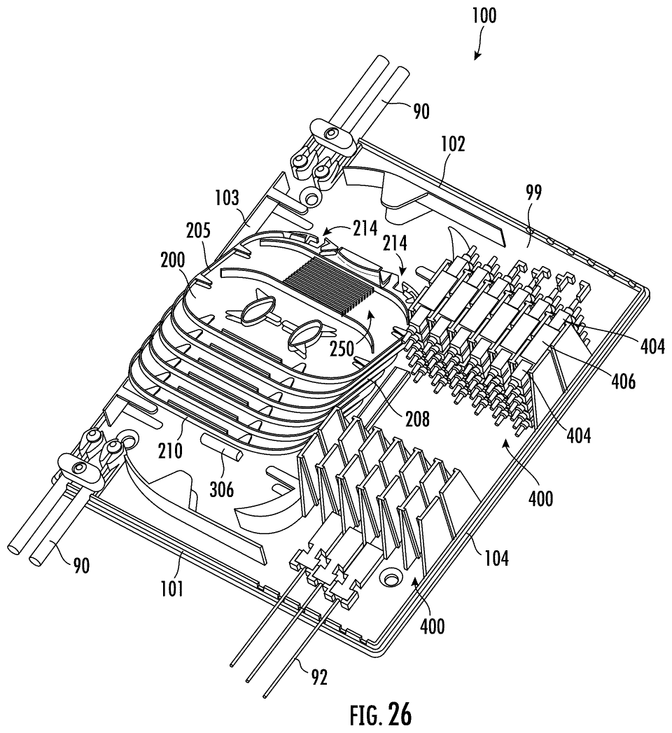

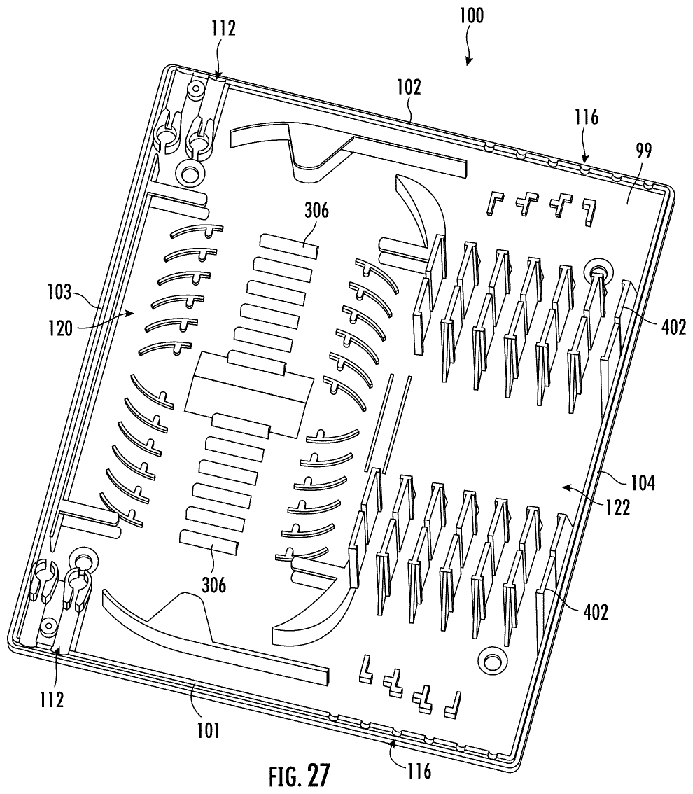

Referring briefly to FIGS. 26-27, perspective views of an embodiment of a closure 100 in accordance with aspects of the present disclosure are provided. Embodiments of the closure 100 provided in FIGS. 26-27 may be configured such as described in regard to FIGS. 1-20. FIGS. 26-27 depict embodiments of the closure 100 at which hinge assemblies 306 are positioned at the base wall 106 of the base tray 99. A plurality of trays 200 is releasably attachable to respective hinge assemblies 306. For instance, the hinge assemblies 306 may be positioned in adjacent arrangement along the first axis 11. The trays 200 attached to the hinge assemblies 306 may stack against one another. In some embodiments, the

Embodiments of the closure 100 provided herein may allow for large lengths of cable and optical fiber slack to be accommodated within the interior volume of the closure 100, such as by allowing iterations of routing along the first axis 11, the second axis 12, or the third axis 13 as described herein.

Embodiments of the closure 100 provided herein may provide a universal housing at which the closure 100 can be rotated, aligned, or mounted in substantially any desired orientation to receive input cables, allow for any desired splices, splitters, connectors, terminations, etc., and allow for cable output in substantially any desired orientation. The closure 100 provides mounting and routing features (e.g., interior walls, retainer tabs, etc.) and a base tray 99, organizer tray 200, and connector bank 400 allowing for substantially any customized configuration of connector, splice, splitter, or termination. Accordingly, embodiments of the closure 100 may be configured as a consolidation closure that can be utilized as a multi-dwelling unit (MDU) breakout box, a mid-span consolidation box, a customizable application box having combinations of connectors, adaptors, cables, fibers, splices, splitters, or other telecommunications devices, or combinations thereof.

Further aspects of the invention are provided by one or more of the following embodiments:
1. A fiber optic closure including a base tray, the base tray including a pair of end walls separated along a first axis and a first side wall extending between the pair of end walls and separated along a second axis from a second side wall extending between the pair of end walls, wherein the second side wall forms a first attachment interface configured to receive a connector bank, and a base wall extending between the end walls and the side walls, wherein the end walls, the side walls, and the base wall at least partially form an interior volume, wherein the interior volume includes a first side proximate to the first side wall and a second side proximate to the second side wall, wherein each end wall at least partially forms an inlet opening extending from an exterior of the closure to the interior volume at the first side. Each end wall at least partially form an outlet opening extending from the exterior of the closure to the interior volume at the second side, the base wall including two or more second attachment interfaces positioned at the first side of the interior volume, the second attachment interfaces configured to receive an organizer tray, wherein at least one second attachment interface is positioned proximate to the first end wall, and wherein at least one second attachment interface is positioned proximate to the second end wall.
2. The fiber optic closure of any one or more clauses herein, wherein the second attachment interfaces are positioned in mirror-imaged arrangement relative to a centerline axis extending along the second axis through the side walls.
3. The fiber optic closure of any one or more clauses herein, including a plurality of interior walls extending from the base wall at the first side; and a retainer tab extending from the plurality of interior walls, wherein the interior walls are arranged in substantially circular, ovular, elliptical, or parabolic arrangement.
4. The fiber optic closure of any one or more clauses herein, wherein the plurality of interior walls are positioned in mirror-imaged arrangement relative to a centerline axis extending along the second axis through the side walls.
5. The fiber optic closure of any one or more clauses herein, including an inner perimeter interior wall positioned outward of the plurality of interior walls; and an outer perimeter interior wall positioned outward of the plurality of interior walls and the inner perimeter interior wall, wherein the inner and outer perimeter walls forming a substantially circular, ovular, elliptical, or parabolic outer track.
6. The fiber optic closure of any one or more clauses herein, including a furcation wall extending along the first axis, wherein the furcation wall separates the first side from the second side.
7. The fiber optic closure of any one or more clauses herein, wherein the furcation wall forms an opening extending into the second side.
8. The fiber optic closure of any one or more clauses herein, wherein the furcation wall forms a routing channel extending along the first axis from proximate to the first end wall to proximate to the second end wall.
9. The fiber optic closure of any one or more clauses herein, wherein the furcation wall forms two or more openings extending from the routing channel to the second side, wherein at least one of the openings is positioned proximate to the first end wall, and wherein at least one of the openings is positioned proximate to the second end wall.
10. The fiber optic closure of any one or more clauses herein, including a bracket assembly extending along a third axis from the base wall, the bracket assembly releasably connectable to the second attachment interface, the bracket assembly including a plurality of hinge assemblies spaced apart along the third axis.
11. The fiber optic closure of any one or more clauses herein, the bracket assembly including a main body releasably connectable to the second attachment interface, wherein the plurality of hinge assemblies is formed at the main body; and a hook extending from the main body, wherein the hook is configured to receive a cable routing therethrough.
12. The fiber optic closure of any one or more clauses herein, the bracket assembly including a main body releasably connectable to the second attachment interface, wherein the plurality of hinge assemblies is formed at the main body; and a retention wall extending from the main body and along the third axis from the main body, the retention wall forming a volume between the retention wall and the main body, wherein the retention wall forms a detent limiting movement of cables within the volume along the first axis.
13. The fiber optic closure of any one or more clauses herein, including an organizer tray releasably connectable to the bracket assembly at the hinge assembly.
14. The fiber optic closure of any one or more clauses herein, the organizer tray including tray end walls configured to extend substantially co-directional to the pair of end walls at the base tray; and tray side walls configured to extend between the tray end walls, wherein an opening is formed between the end wall and adjacent side wall, the opening providing entry and egress to a tray interior volume formed between the tray end walls and the tray side walls.
15. The fiber optic closure of any one or more clauses herein, wherein the base wall forms a groove at the second side, wherein the groove extends substantially along the first axis, the groove positioned at the base wall to extend beneath the connector bank.
16. The fiber optic closure of any one or more clauses herein, including a frame connectable at the second side of the base wall at the first attachment interface, the frame forming the connector bank at which one or more adaptors is connectable.
17. The fiber optic closure of any one or more clauses herein, including at least two accessory areas positioned at the second side, wherein the accessory area is positioned proximate to each of the end walls and the second side wall.
18. The fiber optic closure of any one or more clauses herein, including an outlet wall configured to allow cables to egress the closure from the second side.
19. The fiber optic closure of any one or more clauses herein, wherein each end wall forms at least three inlet openings.
20. The fiber optic closure of any one or more clauses herein, wherein at least two inlet openings include a seal configured to at least mitigate fluid flow between the exterior of the closure and the interior volume.
21. A fiber optic closure, the fiber optic closure including a base tray including a pair of end walls separated along a first axis and side walls separated along a second axis, wherein the end walls and the side walls are in ambidextrous arrangement to allow for cables to enter an interior volume of the closure at a first side of the interior volume and to allow for cables to egress the interior volume of the closure at the second side of the interior volume separated along the second axis from the first side.
22. A cable bank for a fiber optic closure, the cable bank including a detachable cable holder; a body comprising a plurality of openings, wherein the cable holder is selectively insertable into the opening at the body, the body arranging the plurality of openings along a mutually orthogonal first axis, second axis, and third axis.
23. The cable bank of any one or more clauses herein, the body forming a step structure.
24. The cable bank of any one or more clauses herein, the body forming a channel extending through the body, the channel configured to allow a cable to extend through the body.
25. The cable bank of any one or more clauses herein, the cable holder including a holder channel configured to receive a cable.
26. The cable bank of any one or more clauses herein, the holder channel configured to position at or above the channel extending through the body.
27. The cable bank of any one or more clauses herein, the holder channel configured to position at an outside face of the body.
28. The cable bank of any one or more clauses herein, the body including an attachment interface configured to receive a fastener to secure the body to the fiber optic closure.
29. The fiber optic closure of any one or more clauses herein including the cable bank of any one or more clauses herein.
30. The fiber optic closure of any one or more clauses herein including the cable bank of any one or more clauses herein, the cable bank releasably positioned at an accessory area at a second side of the fiber optic closure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fiber optic closure, the closure comprising:
a base tray comprising:
a first end wall separated along a first axis from a second end wall,
a first side wall extending between the pair of end walls and separated along a second axis from a second side wall extending between the pair of end walls, the second side wall forming a first attachment interface configured to receive a connector bank, and
a base wall extending between the end walls and the side walls,
wherein the end walls, the side walls, and the base wall at least partially form an interior volume, the interior volume comprising a first side proximate to the first side wall and a second side proximate to the second side wall,
wherein each end wall at least partially forms an inlet opening extending from an exterior of the closure to the interior volume at the first side, and
wherein each end wall at least partially form an outlet opening extending from the exterior of the closure to the interior volume at the second side,
wherein the base wall comprises two or more second attachment interfaces positioned at the first side of the interior volume, the second attachment interfaces configured to receive an organizer tray, wherein at least one second attachment interface is positioned proximate to each end wall.

2. The fiber optic closure of claim 1, wherein the second attachment interfaces are positioned in mirror-imaged arrangement relative to a centerline axis extending along the second axis through the side walls.

3. The fiber optic closure of claim 1, comprising:
a plurality of interior walls extending from the base wall at the first side; and
a retainer tab extending from the plurality of interior walls, wherein the interior walls are arranged in substantially circular, ovular, elliptical, or parabolic arrangement.

4. The fiber optic closure of claim 3, wherein the plurality of interior walls are positioned in mirror-imaged arrangement relative to a centerline axis extending along the second axis through the side walls.

5. The fiber optic closure of claim 3, comprising:
an inner perimeter interior wall positioned outward of the plurality of interior walls; and
an outer perimeter interior wall positioned outward of the plurality of interior walls and the inner perimeter interior wall, wherein the inner and outer perimeter walls forming a substantially circular, ovular, elliptical, or parabolic outer track.

6. The fiber optic closure of claim 1, comprising:
a furcation wall extending along the first axis, wherein the furcation wall separates the first side from the second side.

7. The fiber optic closure of claim 6, wherein the furcation wall forms an opening extending into the second side.

8. The fiber optic closure of claim 6, wherein the furcation wall forms a routing channel extending along the first axis from proximate to the first end wall to proximate to the second end wall.

9. The fiber optic closure of claim 8, wherein the furcation wall forms two or more openings extending from the routing channel to the second side, wherein at least one of the openings is positioned proximate to the first end wall, and wherein at least one of the openings is positioned proximate to the second end wall.

10. The fiber optic closure of claim 1, comprising:
a bracket assembly extending along a third axis from the base wall, the bracket assembly releasably connectable to the second attachment interface, the bracket assembly comprising a plurality of hinge assemblies spaced apart along the third axis.

11. The fiber optic closure of claim 10, the bracket assembly comprising:
a main body releasably connectable to the second attachment interface, wherein the plurality of hinge assemblies is formed at the main body; and
a hook extending from the main body, wherein the hook is configured to receive a cable routing therethrough.

12. The fiber optic closure of claim 10, the bracket assembly comprising:
a main body releasably connectable to the second attachment interface, wherein the plurality of hinge assemblies is formed at the main body; and
a retention wall extending from the main body and along the third axis from the main body, the retention wall forming a volume between the retention wall and the main body, wherein the retention wall forms a detent limiting movement of cables within the volume along the first axis.

13. The fiber optic closure of claim 10, comprising:
an organizer tray releasably connectable to the bracket assembly at the hinge assembly.

14. The fiber optic closure of claim 13, the organizer tray comprising:
tray end walls configured to extend substantially co-directional to the pair of end walls at the base tray; and
tray side walls configured to extend between the tray end walls, wherein an opening is formed between the end wall and adjacent side wall, the opening providing entry and egress to a tray interior volume formed between the tray end walls and the tray side walls.

15. The fiber optic closure of claim 1, wherein the base wall forms a groove at the second side, wherein the groove extends substantially along the first axis, the groove positioned at the base wall to extend beneath the connector bank.

16. The fiber optic closure of claim 1, comprising:
a frame connectable at the second side of the base wall at the first attachment interface, the frame forming the connector bank at which one or more adaptors is connectable.

17. The fiber optic closure of claim 1, comprising:
at least two accessory areas positioned at the second side, wherein the accessory area is positioned proximate to each of the end walls and the second side wall.

18. The fiber optic closure of claim 1, comprising:
an outlet wall configured to allow cables to egress the closure from the second side.

19. The fiber optic closure of claim 1, wherein each end wall forms at least three inlet openings.

20. The fiber optic closure of claim 19, wherein at least two inlet openings comprise a seal configured to at least mitigate fluid flow between the exterior of the closure and the interior volume.
